(19) United States
(12) Patent Application Publication
(10) Pub. No.: US 2010/0285437 A1
(43) Pub. Date: Nov. 11, 2010

(54) DIDACTIC TOOLS FOR LEARNING MATHEMATICS

(76) Inventor: Natasa Radas, Split (HR)

Correspondence Address: KATHLEEN T. PETRICH, GRAHAM & DUNN PC, 2801 ALASKAN WAY, SUITE 300 - PIER 70, SEATTLE, WA, 98121-1128, US

(21) Appl. No.: 12/811,259

(22) PCT Filed: Dec. 31, 2007
(86) PCT No.: PCT/HR07/00057

§ 371 Date: Jun. 30, 2010

(51) Int. Cl. G09B 1/00

(52) U.S. Cl. 434/207; 434/209; 434/210

(57) ABSTRACT

Didactic tools for learning mathematics contain a set of jigsaws, inserters, abacuses, three-dimensional arrangeable and separable models, mental maps, arranging pads, Multiplication tables without numbers, cylinders, and other spatially situated mathematical sizes and open the possibility of many combinations for arranging and displaying mathematical contents. These contents range from mathematical basis (relations, numbers and spaces, shapes and quantities) to theorems and rules of higher mathematical levels (multiplication, division, squaring, cubing, Pitagora's and binomial theorem, sum of square sequences and other regularities, some of which are new and unknown). With their inner consistency and coherence, they enable numerous combinations and research, and every tools can function independently in a clear and unambiguous way, based on natural mental abilities of logics and perception, close even to the earliest pre-school age. There is no need for additional instructions and lessons, or the knowledge of mathematical language, because the rules and relations are not proved by formulas, but are shown in a visible and tangible way. All this is achieved with a realistic display of quantities and their relations, the shape, position and colour, with the help of squares and cubeletes. It all enables arranging, categorizing, equalizing, joining, sequencing etc., so that adding or mere counting is sufficient for checking the visible quantities and their relations. They vividly enable discovery and understanding of mathematical laws by direct noting, by themselves. In that way they provide the joy of cognition, which enables more pleasurable, faster and easier understanding, practicing and memorizing.

### 1. FIELD OF APPLICATION

The invention relates to didactic tools for learning mathematics which enable early understanding of basic mathematical concepts via natural, developmental, perceptive and mental abilities accompanied by active, creative, and individual hand, eye and brain usage.

The subject of the invention belongs to area G—physics; class G 09—teaching; subclass G 09 B—teaching tools, or the tools for demonstration and instruction; group 1/00 manual or mechanical teaching tools that form or contain symbols, signs, images and the like, or are adjusted to arranging in one or several ways; and group 23/00, under which come models for mathematical purposes, such as demonstrative devices in natural size.

### 2. TECHNICAL PROBLEM

Working on the early rehabilitation of developmental disorders, I have experienced everything necessary for speech, reading and writing development, learning in general, and particularly learning mathematics.

I got acquainted with the existing didactic tools for learning mathematics and with their shortcomings, and became aware of the necessity of making didactic tools closer and more interesting to children, without losing instructiveness and mathematical logics.

Technical problem solved by this invention relates to didactic tools for learning mathematics that will enable early understanding of basic mathematical concepts on several levels via natural, developmental, perceptive and mental abilities, accompanied by active, creative, and individual use of hand, eye and brain.

### 3. STATE OF THE ART

General learning of mathematics and the didactic offer are related to a sudden appearance of learning the mathematical language, symbols and formulas, which made possible skipping of displaying real mathematical relations between quantities—numbers, as well as skipping of relations of a number and space in a clear, visible and tangible way. Mathematical logics remains hidden to perception, and learning adds up to practicing relations between symbols. The existing didactic tools follow such an approach.

All mentioned didactic aids have their shortcomings, obvious in the following:
Inadequate mathematic learning methodic which, among the rest, begins late, (skipping the early development of comprehension, perception and natural logics), inhibits research development and lowers the didactic offer, at the same time losing its support for further gaining and deepening of knowledge.
A possibility of research and creative activity, leading to the necessary basic knowledge and concepts, is not embedded into the existing didactic tools. Even if they do awake creativity, they are at loss in gaining knowledge and concepts, and even if oriented towards gaining knowledge, they are often boring, and deprived of research.
The attempts of eliminating boredom by introducing games are reduced to creating external fun not necessarily connected to the subject of learning.
The tools are burdened by additional instructions which need to be read and mastered before use and which are often technically inadequate.
The novelty is in the new way of usage where the knowledge is not gained, but only practiced.
The knowledge is often given in its final shape, which eliminates the original joy of exploration and comprehension.
Inexistence of several levels of cognition in the same tools with application value for the young and the elderly, for the more and less competent, and for those who master the teaching material with difficulties and those who master it easily.
Individual tools satisfy only a certain level of skills and knowledge.
It has not been possible also to develop pre-skills and skills at the same time.
Sets with inner coherence and consistency in which certain technical solutions are clearly connected, but can also function separately, are rare.
Sets that, based on natural abilities of younger children, lead to higher level comprehension are rare.
Sets that provide graduality in gaining knowledge are rare.

### 4. DISCLOSURE OF THE INVENTION

The essence of the invention are didactic tools for learning mathematics that are interrelated by a common way of functioning—arranging according to colour—which is the principle of the arranging, and is systematically related to numeric value. The numeric value is, beside by colour, displayed by the quantity of unit values, which makes it the real display of quantities and their relations, and enables the possibility of it being checked by counting. In all didactic tools, an example of constant 10 colours is chosen, which range from light to dark as numbers range from lower to higher. An example of a constant display of unit values is also chosen, with a square on the arranging pad and a cubelet with its belonging parts.

The diversity of mathematical contents is displayed by different organizations of colours and quantities in space, i.e. by different shape and position.

These didactic tools, via natural logics and mathematical pre-skills (categorizing, associating, equalizing, and sequencing, etc.), and not via mathematical symbolic language and formulas that need to be memorized, make mathematical relations understandable in a visible and tangible way.

Didactic tools for learning mathematics, according to this invention, embrace:
JIGSAWS—INSERTERS—didactic tools in form of a board with a drawing. The boards have a dent for arranging symbols (numbers and letters) in pieces and/or in layers, and square pits for arranging squares.
MULTIPLICATION TABLE WITHOUT NUMBERS—didactic tools with a pad in form of a square with 100 geometrical figures (10 squares and 90 rectangles) in 10 colours and 100 solids (10 quadratic and 90 rectangular prisms) in the same 10 colours as in the pad.
JIGSAWS WITH THE MULTIPLICATION TABLE WITHOUT NUMBERS:
   1-10 jigsaw—didactic tools with pads for arranging numbers from 1 to 10.
   Numeral lines jigsaw—didactic tools with pads for arranging numeral lines of positive and negative numbers from −20 to +20.
   Decimal system jigsaw—didactic tools with pads in three parts for the decimal system and the positional notation of numbers from 1 to 199.
   Cubes jigsaw—didactic tools that uses all the parts of the Multiplication table without numbers, as well as 10 squares of the main diagonal on an arranging table pad, and 10 boxes of the same colour and size as are the arranging parts.
   Binomial theory jigsaw
   Sequences jigsaw—didactic tools for the sequences of squares of numbers from 1 to 10 that uses 10 parts of the Multiplication table without numbers, which are situated on the main diagonal of the Table, and have a quadratic basis.
JIGSAW FOR THE DECIMAL SYSTEM AND THE POSITIONAL NOTATION OF NUMBERS—CYLINDERS—didactic tools made of 3 cylinders which spin separately on the same axis and serve for displaying the decimal system and positional notation of numbers from 1 to 999.
MULTIPLICATION TABLE IN HEIGHT—didactic tools with a pad made of 100 squares in 10 colours, and 100 parts in form of quadratic prisms with one square basis, the size and the number of the cubeletes being identical to the size of the sum.
100 CUBES MULTIPLICATION TABLE—didactic tools with 6 basic pads and 100 data cubes.
MENTAL MAPS IN LAYERS—TRANSPARENCIES—didactic tools in form of equally sized grouped transparencies, used for displaying certain contents, every of which separately contains a part of the wanted information. By arranging one on top of the other, or by taking off particular transparencies, the information are joined or eliminated, thus enabling arranging and displaying:
   symbols and quantity of numbers and letters
   Multiplication table without numbers
   numbers from 1 to 10
   numeral lines—with positive and negative numbers
   decimal system and positional notation of numbers
   cubes—on squares in a certain colour
   square sequence—calculation of the square of the sum
   binomial theorem using the Multiplication table without numbers
   Pitagora's theorem using the Multiplication table without numbers
   squaring the circle using the Multiplication table without numbers
   cylinder sheet
   binomial theorem using 100 cubes multiplication table
   Pitagora's theorem using the 100 cubes multiplication table
   two-way rotational table
   different data of the 100 cubes multiplication table
   other mathematical contents
   logical schemes (categorizing and the like)
   other schemes of any wanted contents
OPAQUE FRAMES WITH EMPTY SPACES—didactic tools for displaying separated parts containing data. By arranging several frames one on top of the other, the wanted order is enabled.

### 5. ILLUSTRATION DESCRIPTIONS

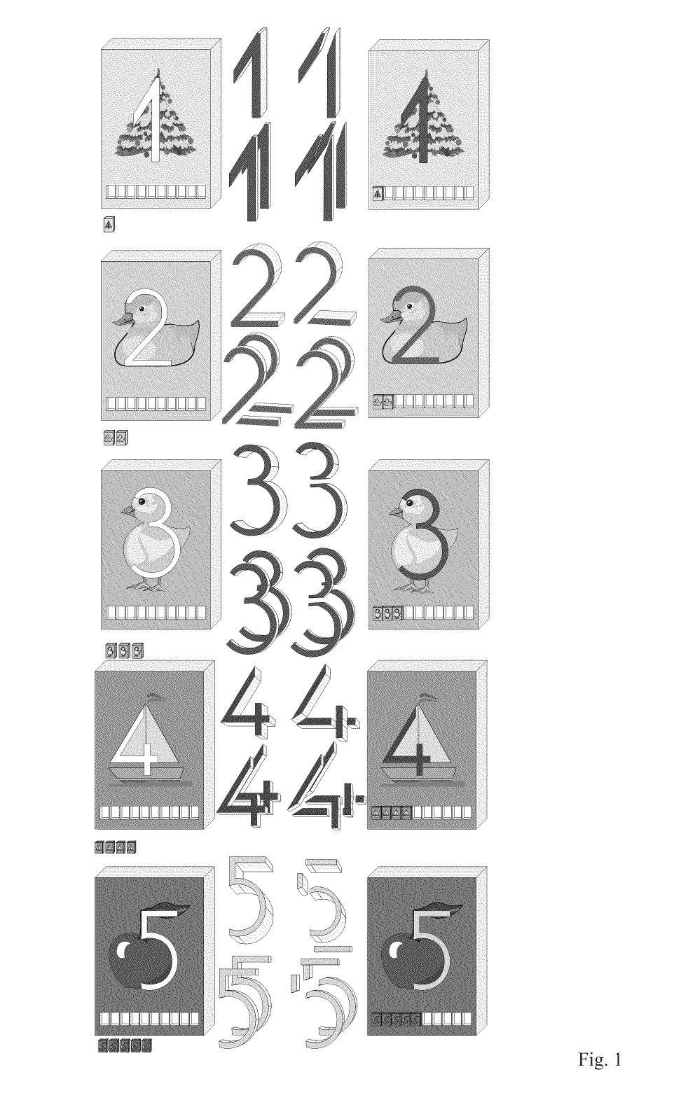

FIG. 1. JIGSAWS—INSERTERS of numbers from 1 to 5

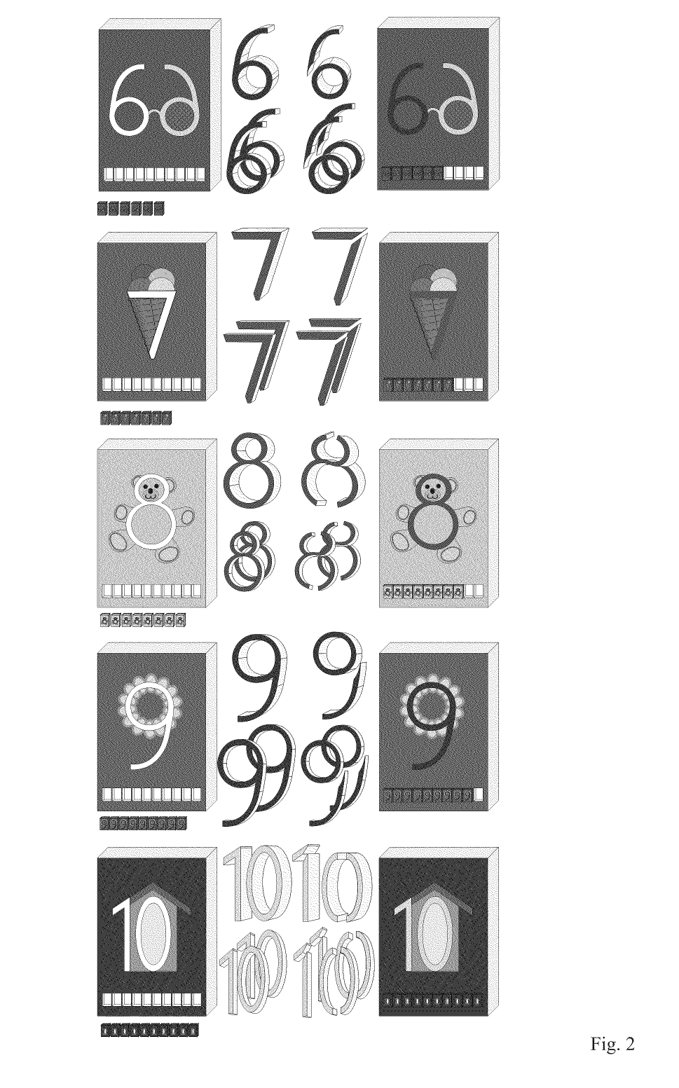

FIG. 2. JIGSAWS—INSERTERS of numbers from 6 to 10

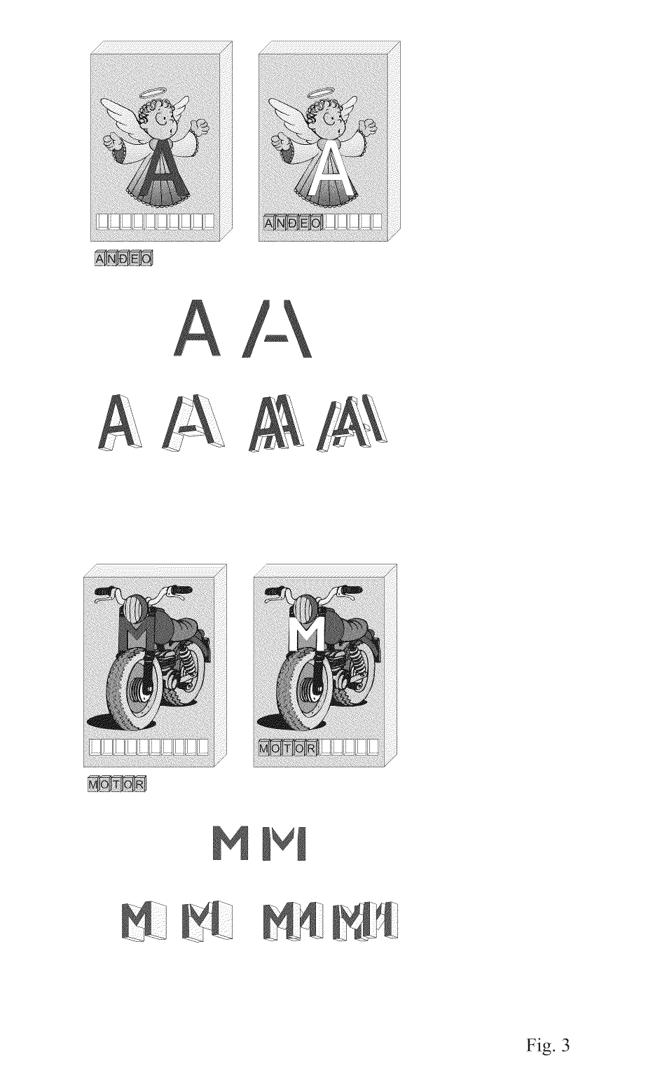

FIG. 3. JIGSAWS—INSERTERS example for letters A and M

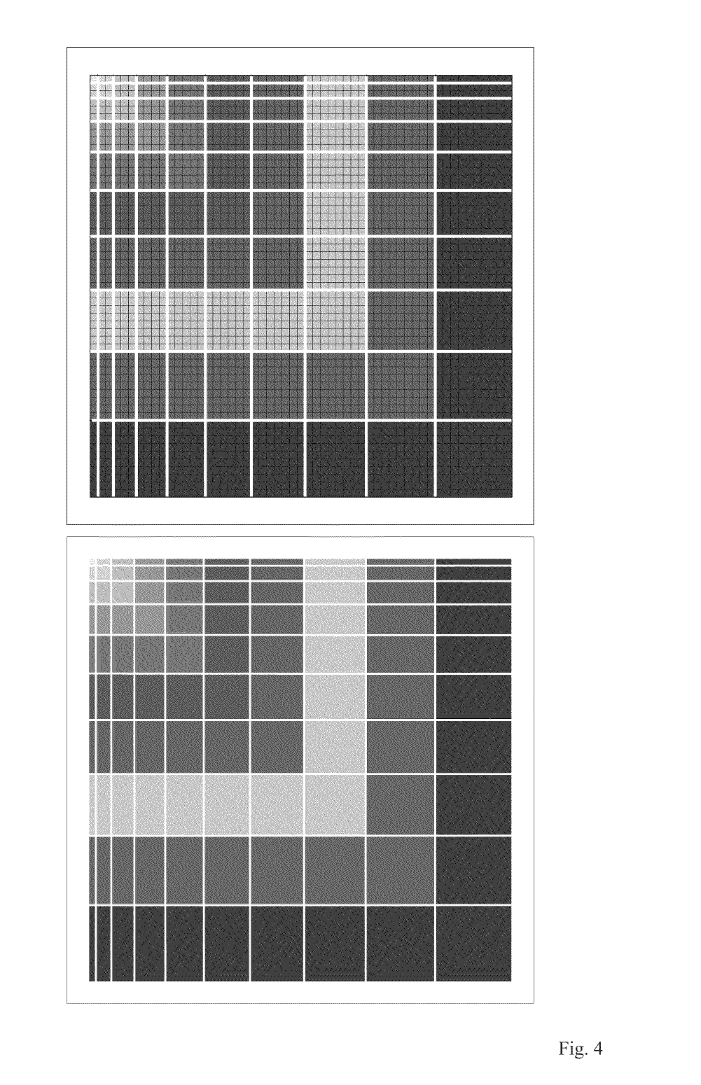

FIG. 4. MULTIPLICATION TABLE WITHOUT NUMBERS coloured pads with a transparency with drawn squares (up), and without the transparency (down)

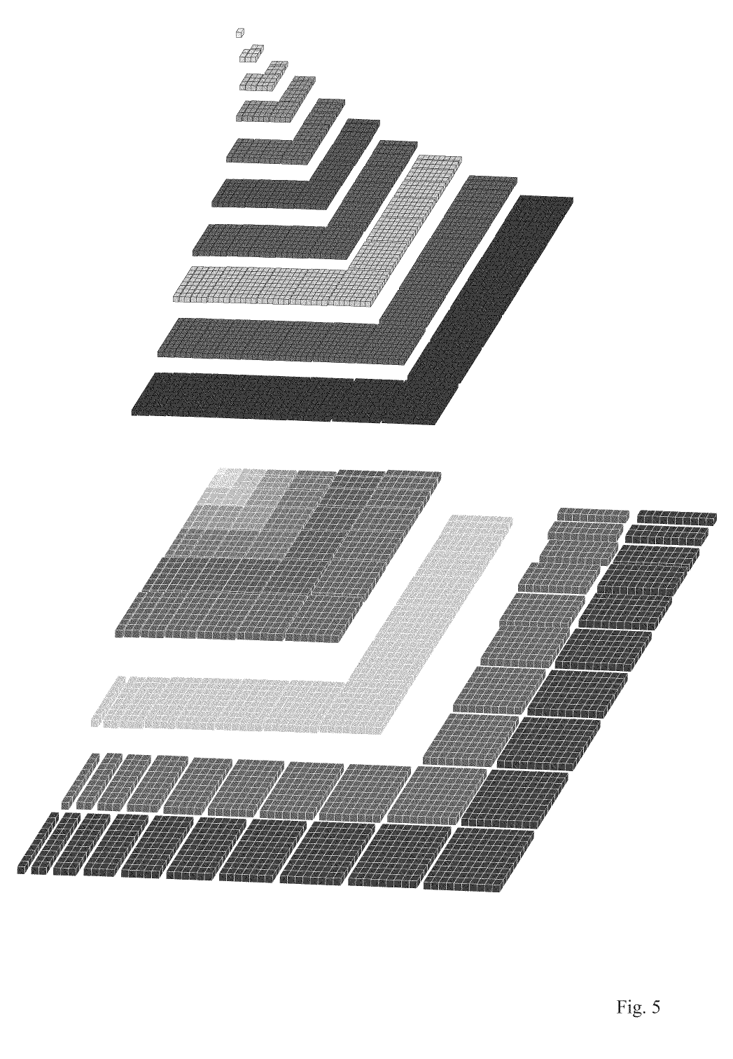

FIG. 5. Spaced parts of the MULTIPLICATION TABLE WITHOUT NUMBERS (up and down)

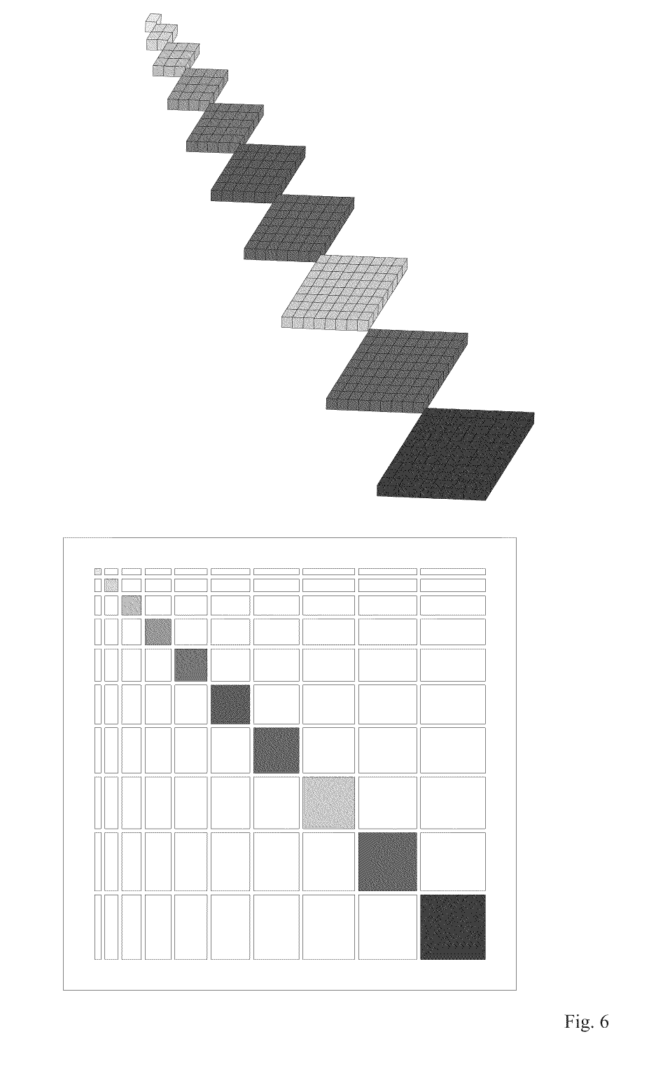

FIG. 6. Parts of the MULTIPLICATION TABLE WITHOUT NUMBERS from the main diagonal (up), and a MULTIPLICATION TABLE WITHOUT NUMBERS transparency with the products of multiplication on the main coloured diagonal

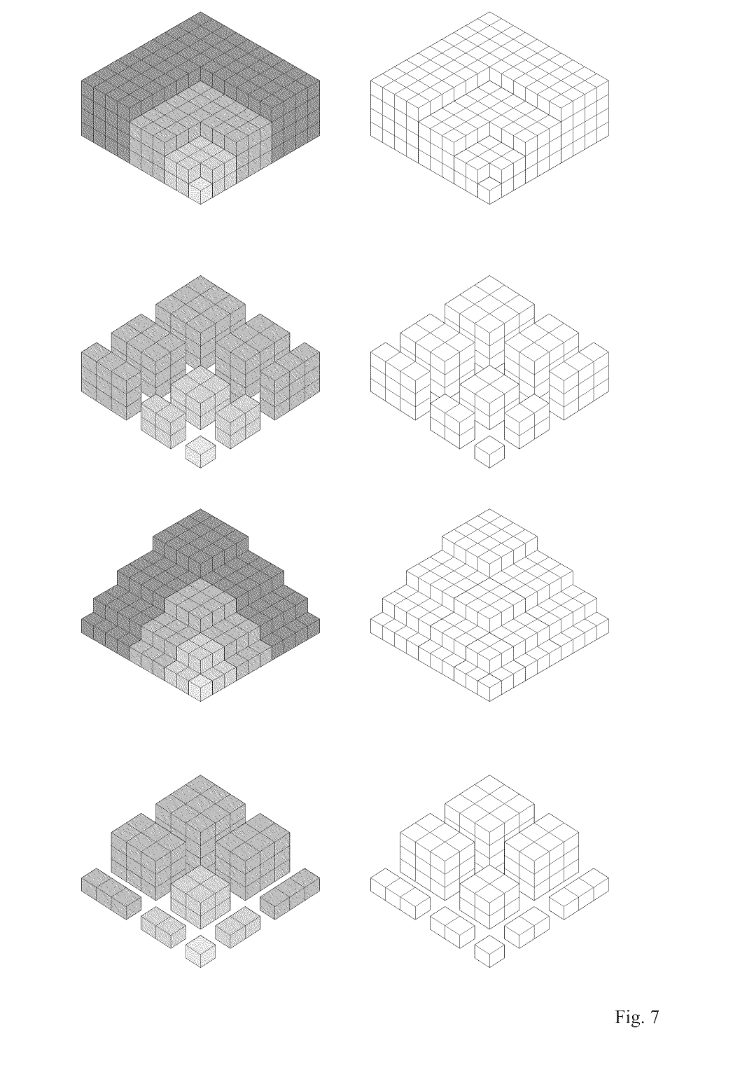

FIG. 7. Variants of parts of the MULTIPLICATION TABLE WITHOUT NUMBERS with different height growths

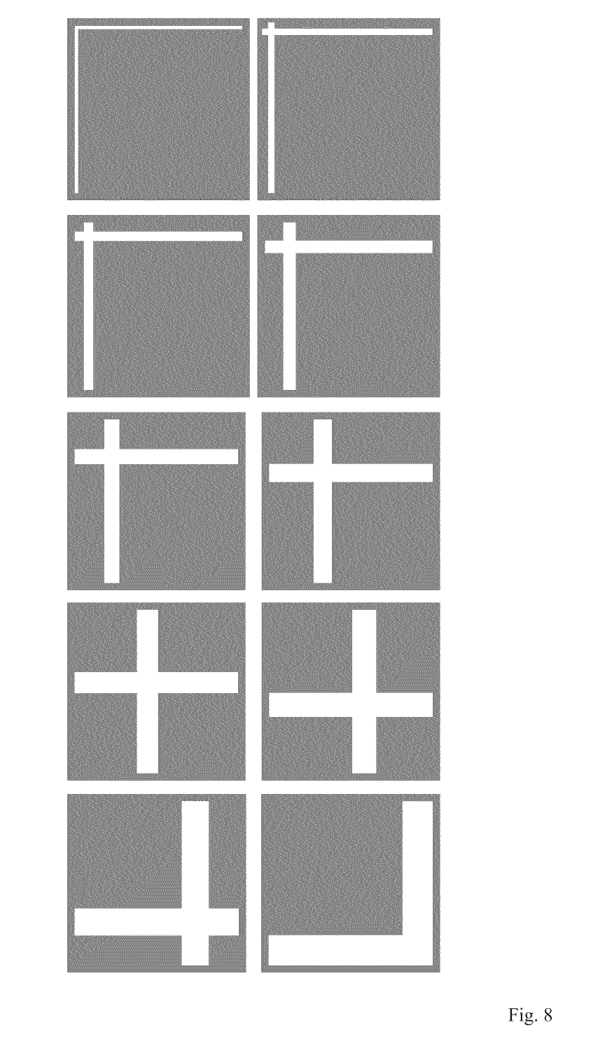

FIG. 8. Frames with empty spaces for arranging products of multiplication from 1 to 10 of the MULTIPLICATION TABLE WITHOUT NUMBERS

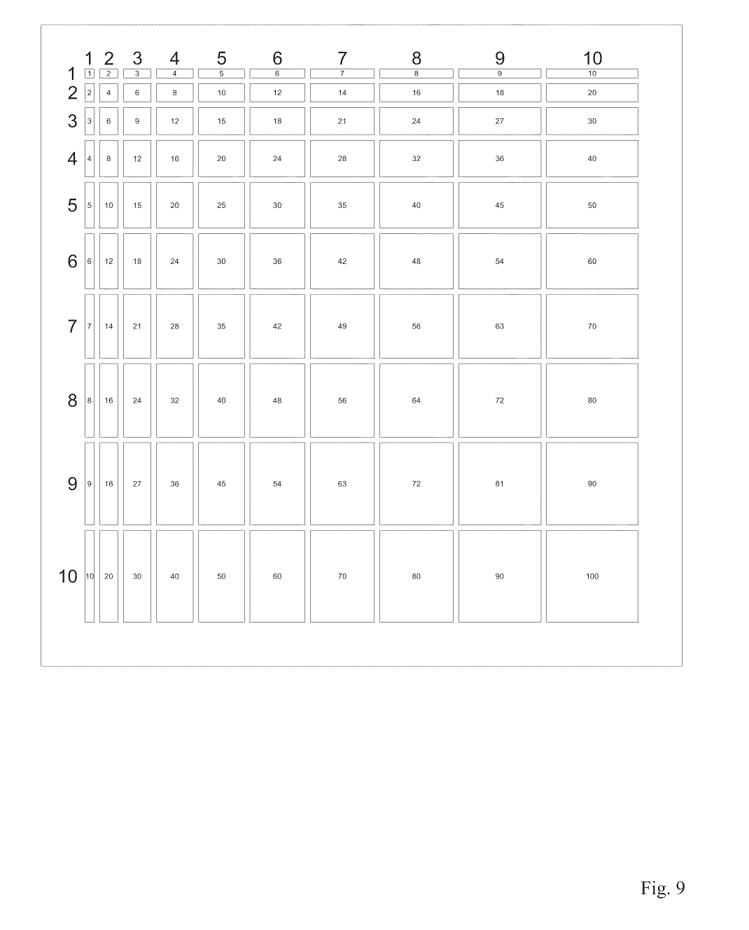

FIG. 9. Transparencies with indicated symbols—the products of multiplication in their places, and factors on the sides of the MULTIPLICATION TABLE WITHOUT NUMBERS

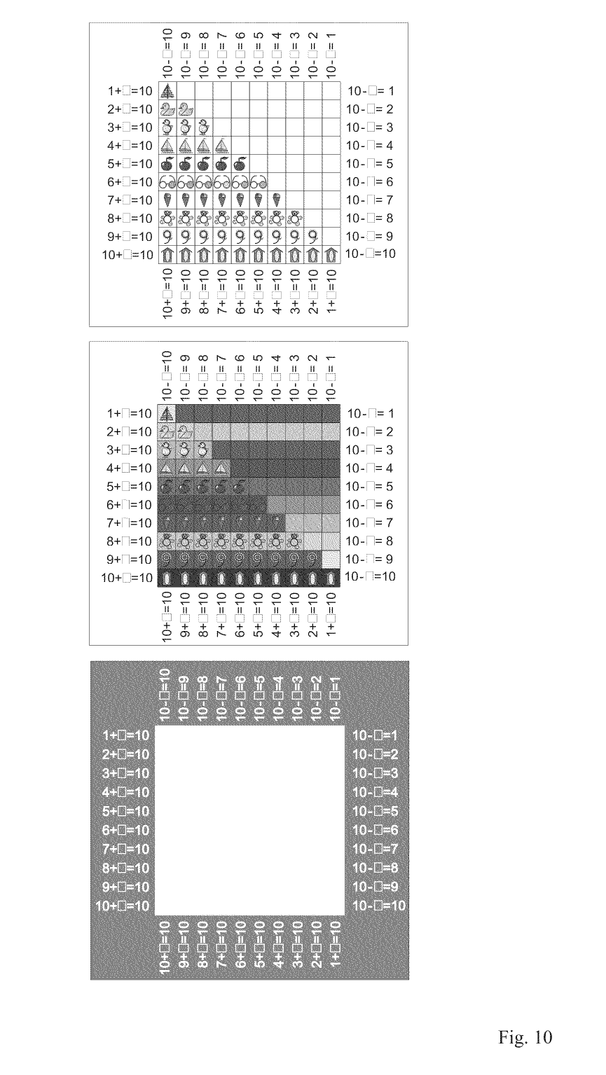

FIG. 10. Transparencies with drawings of numbers—up, on a pad with a frame—in the middle, and a frame—down, of the 1-10 JIGSAW

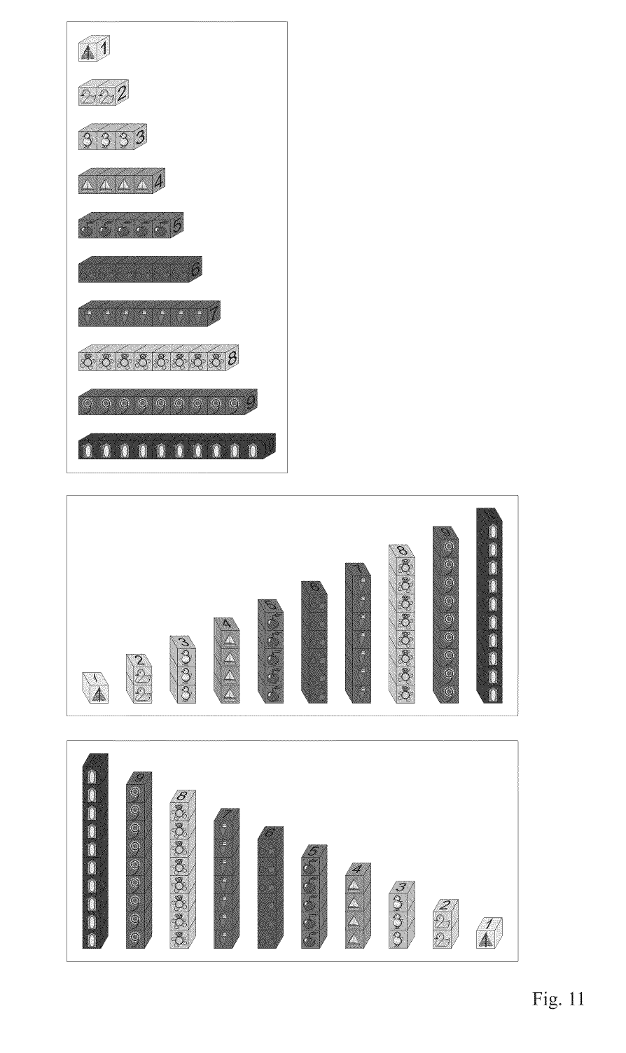

FIG. 11. Parts of the 1-10 JIGSAW with stickers

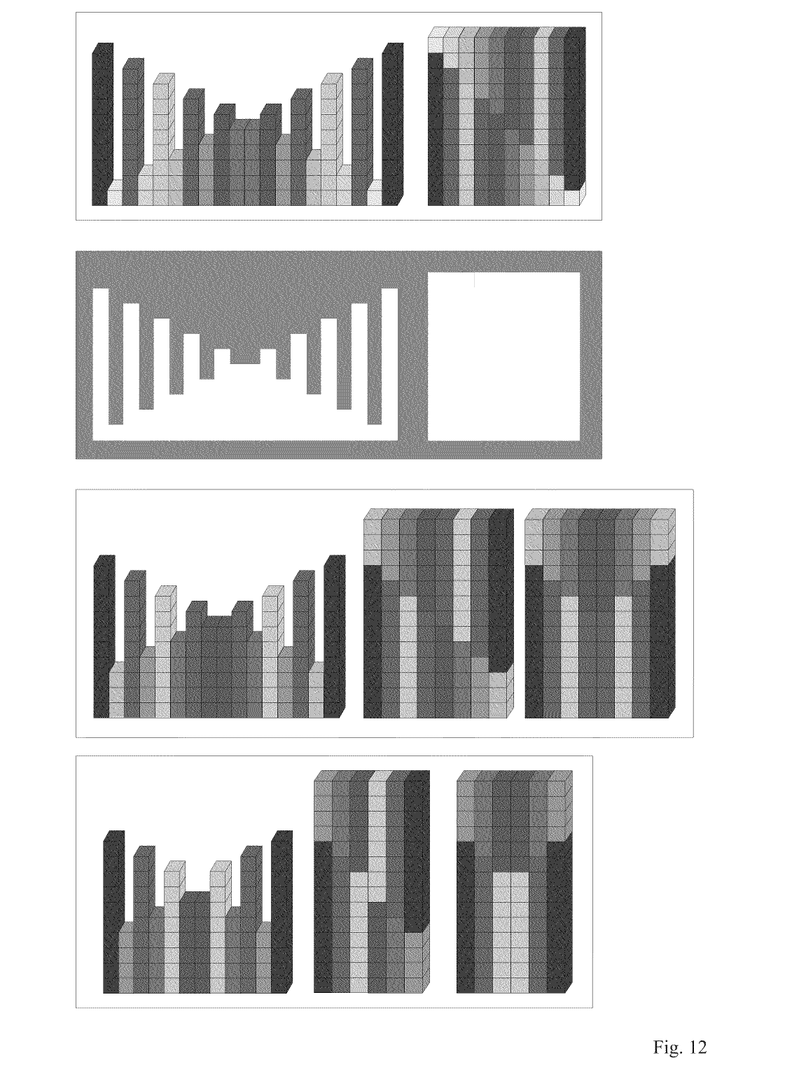

FIG. 12. Parts of the 1-10 JIGSAW, showing number 11 in two ways—first row; frames for number 11—second row; number 13—third row; and number 14—fourth row, in two ways

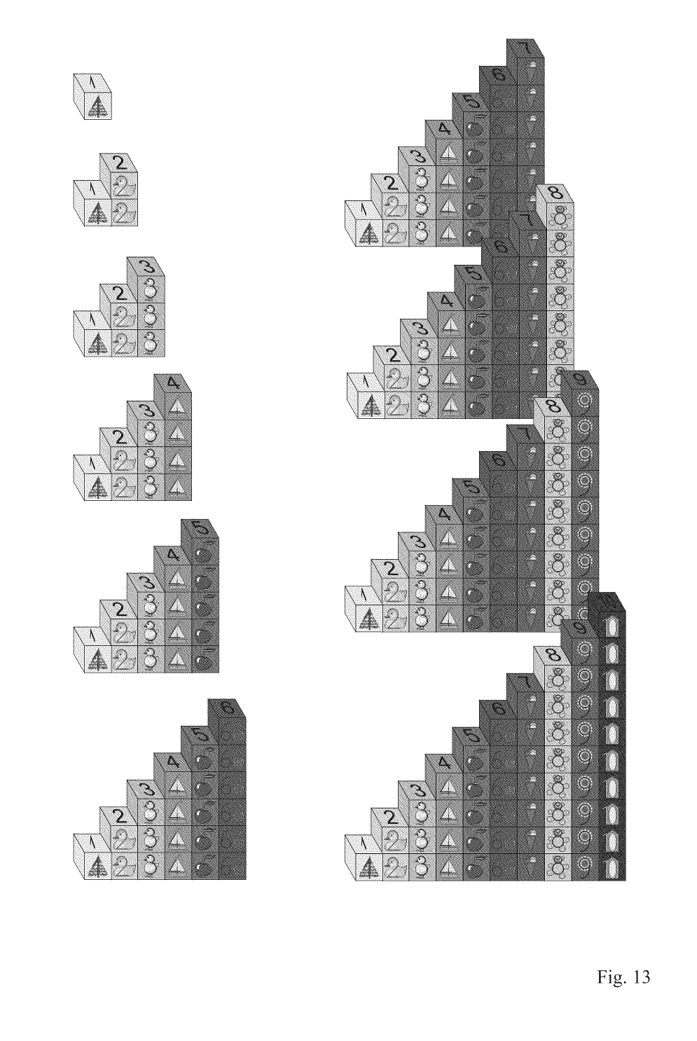

FIG. 13. Parts of the 1-10 JIGSAW, arranged in sequences from 1 to 55

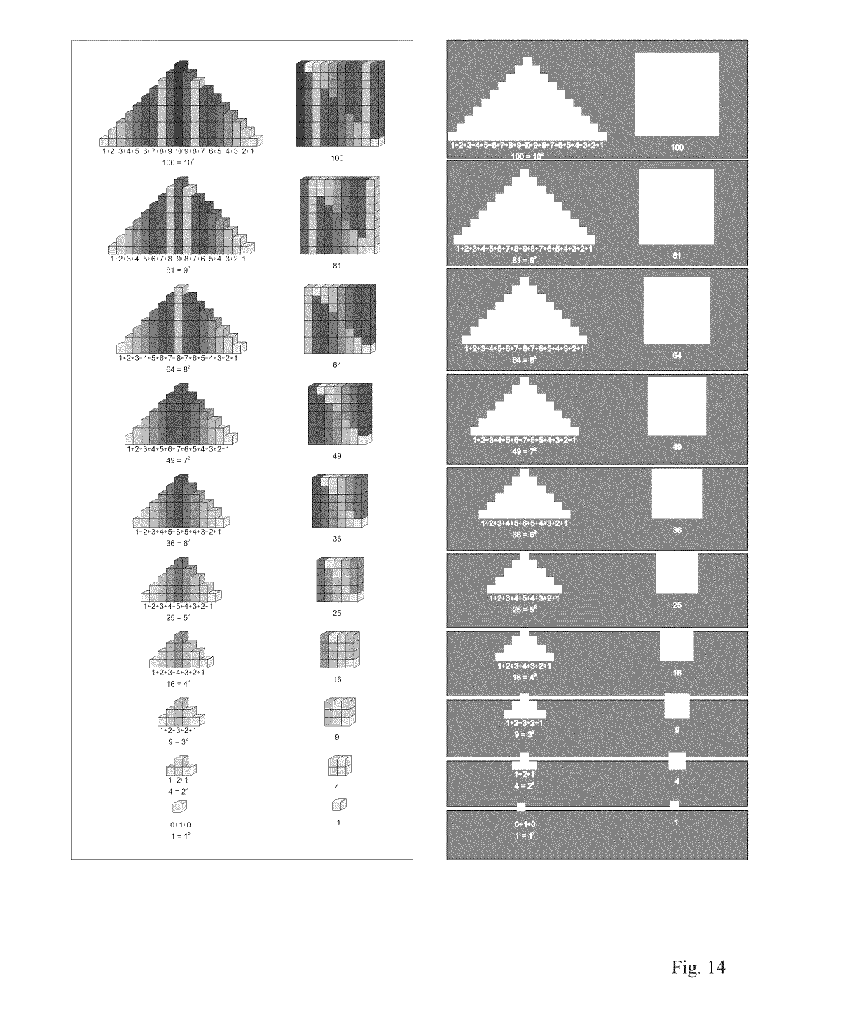

FIG. 14. Parts of the 1-10 JIGSAW, showing growth from 1 to 10 and a decrease to 1, arranged stepwise and in coloured squares (left column), and arranging frames

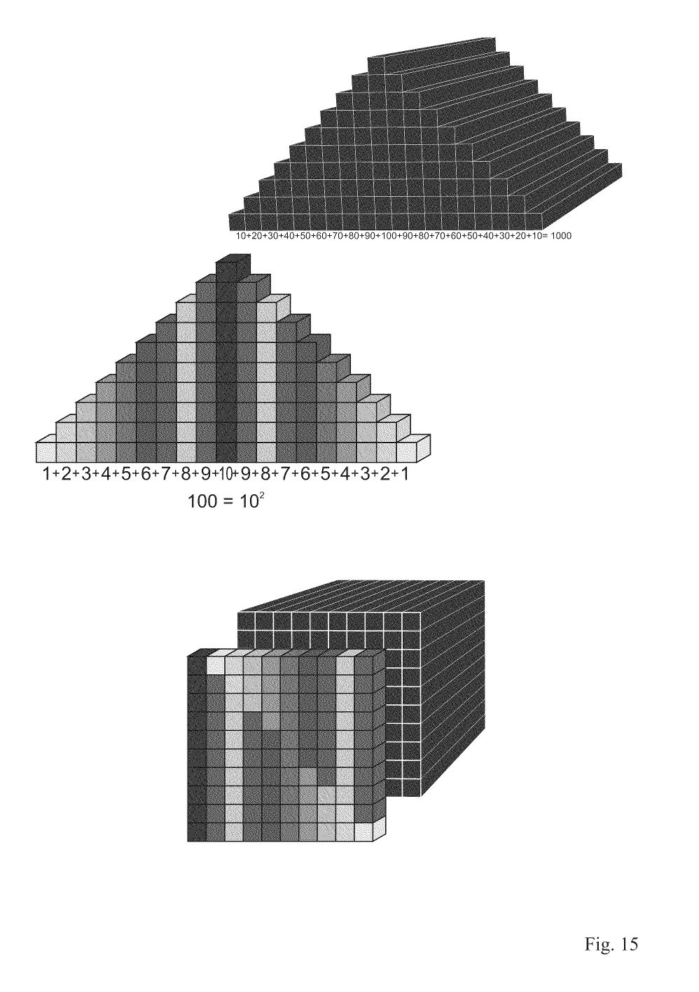

FIG. 15. Parts of the 1-10 JIGSAW, showing growth from 1 to 10 and a decrease to 1, in colour, behind of which the same numbers are multiplied by 10—the dark blue ones—up, and the same numbers arranged in squares and multiplied by 10 into an dark blue cube—down

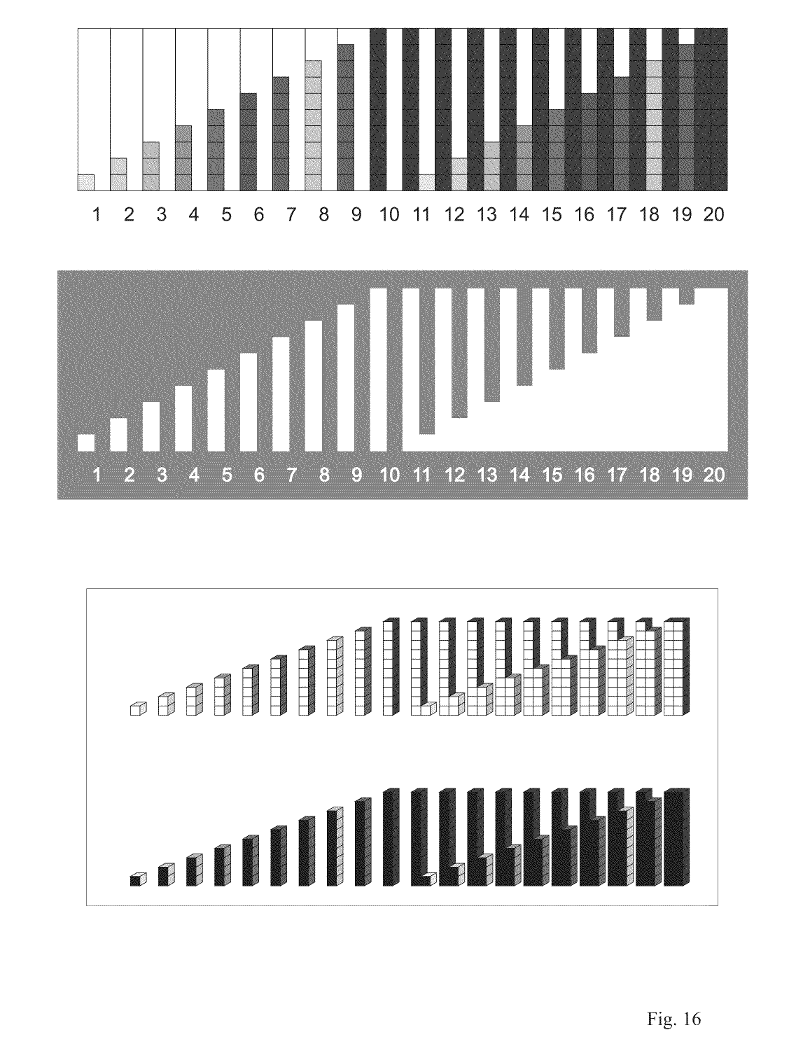

FIG. 16. A coloured transparency for NUMERAL LINES JIGSAW from 1 to 20 (up), a frame (in the middle), and arranging parts observed form the front and from the back

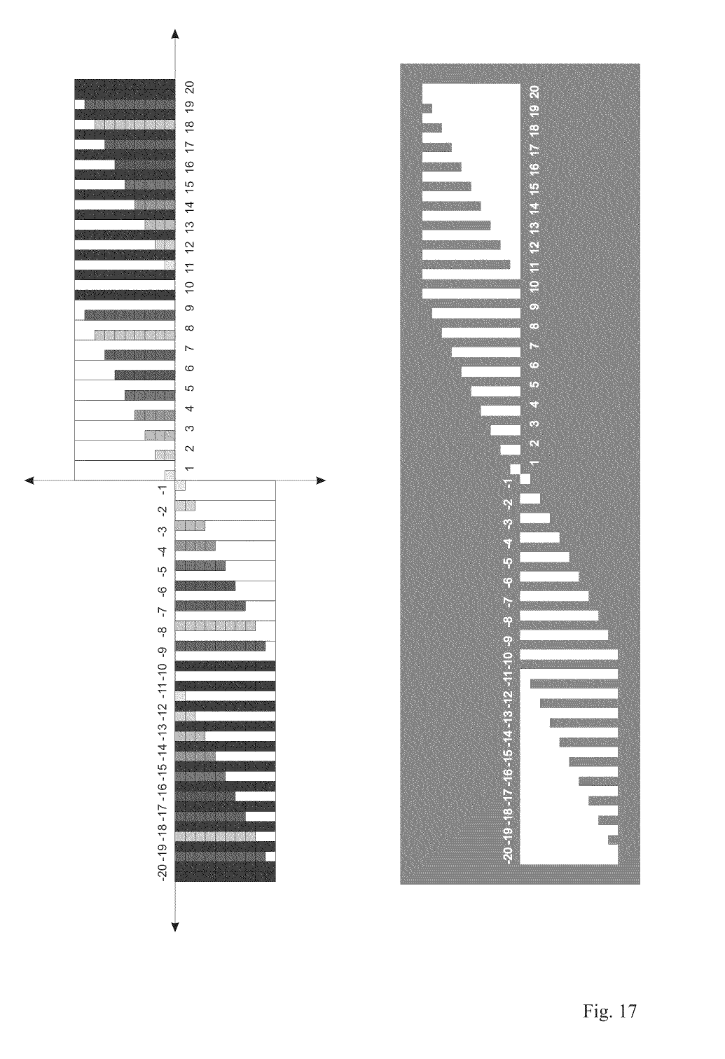

FIG. 17. A coloured transparency for the NUMERAL LINES JIGSAW from −20 to 20

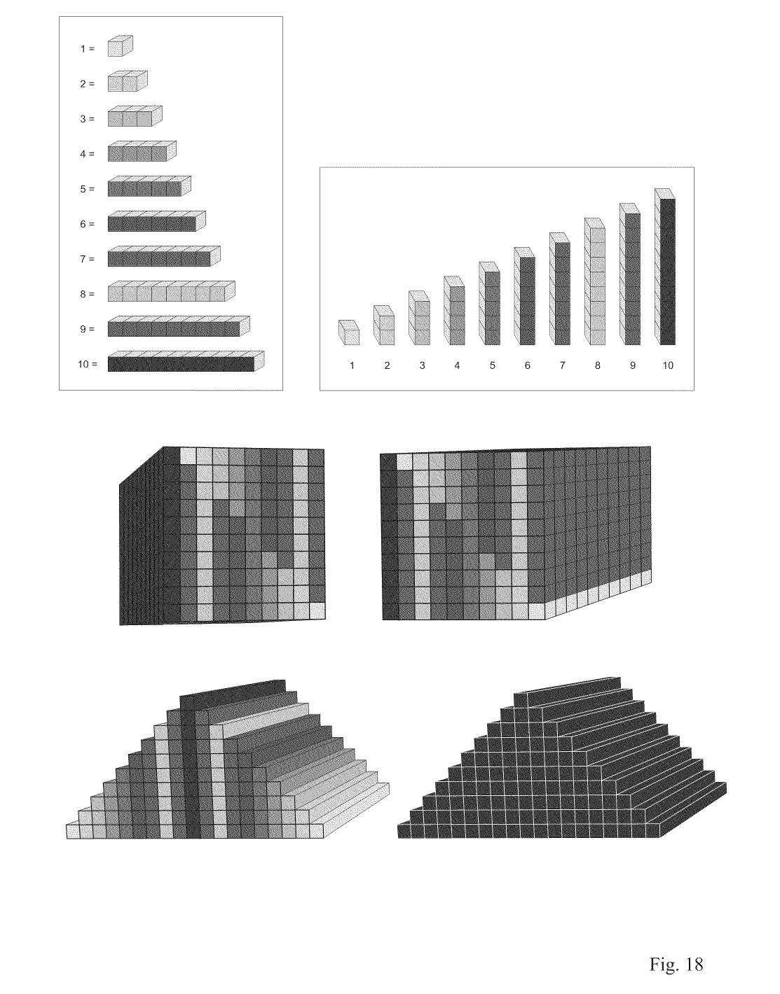

FIG. 18. Parts of ones of the DECIMAL SYSTEM JIGSAW (up), and tens arranged in a cube (in the middle), and parts of the tens arranged stepwise with the dark blue parts of the MULTIPLICATION TABLE WITHOUT NUMBERS

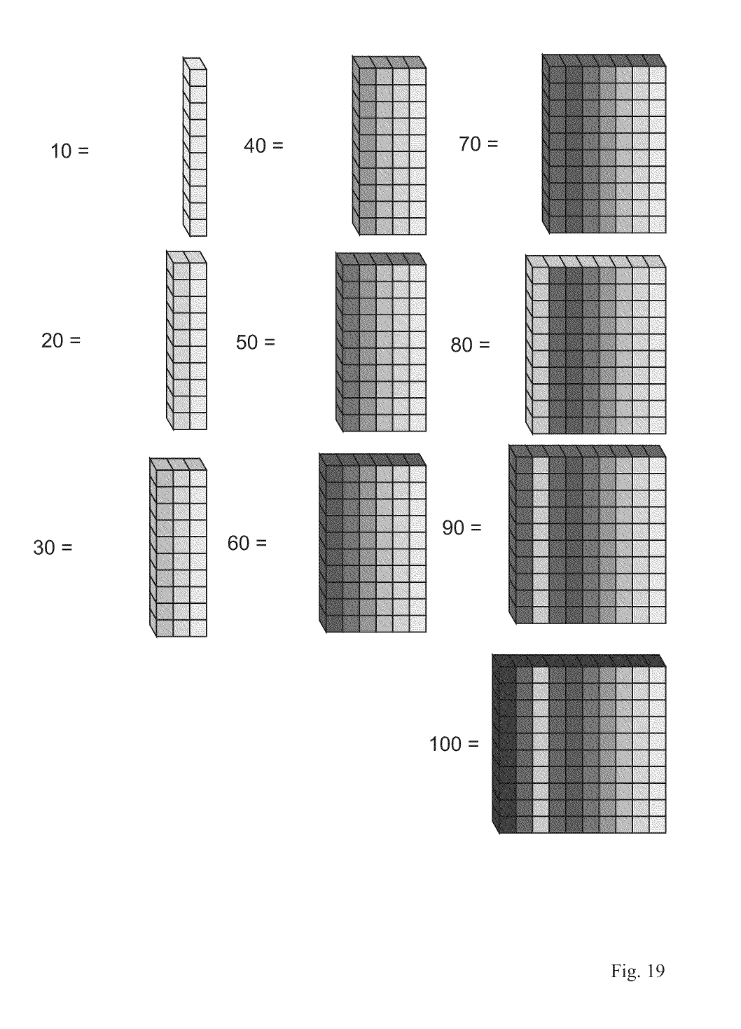

FIG. 19. Parts of tens of the DECIMAL SYSTEM JIGSAW, from the coloured side in several colours times ten

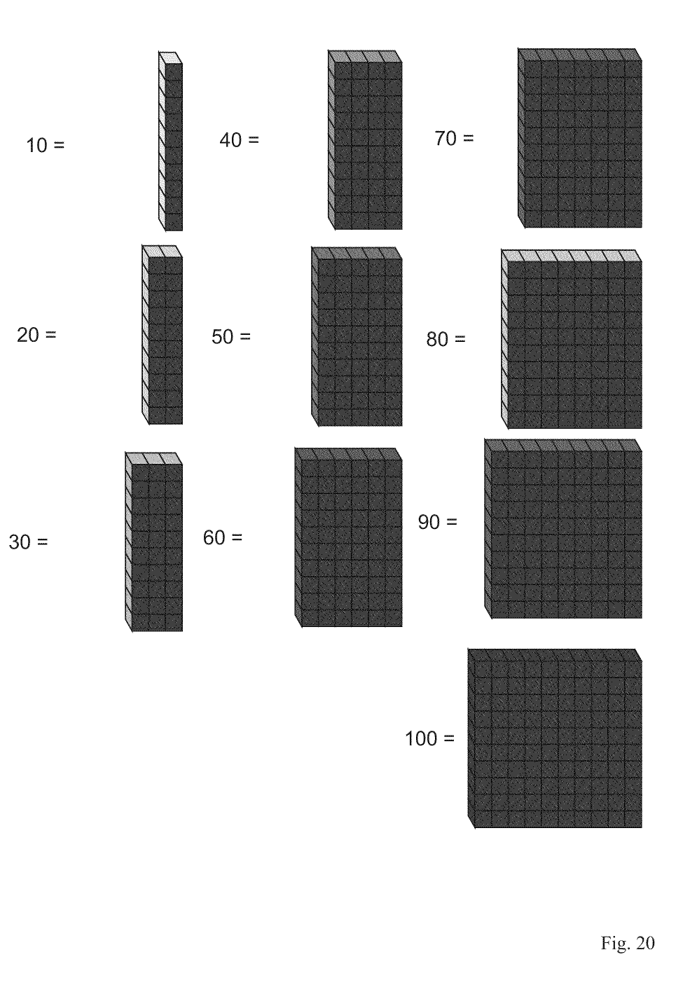

FIG. 20. Parts of tens of the DECIMAL SYSTEM JIGSAW, the back dark blue side of the same parts

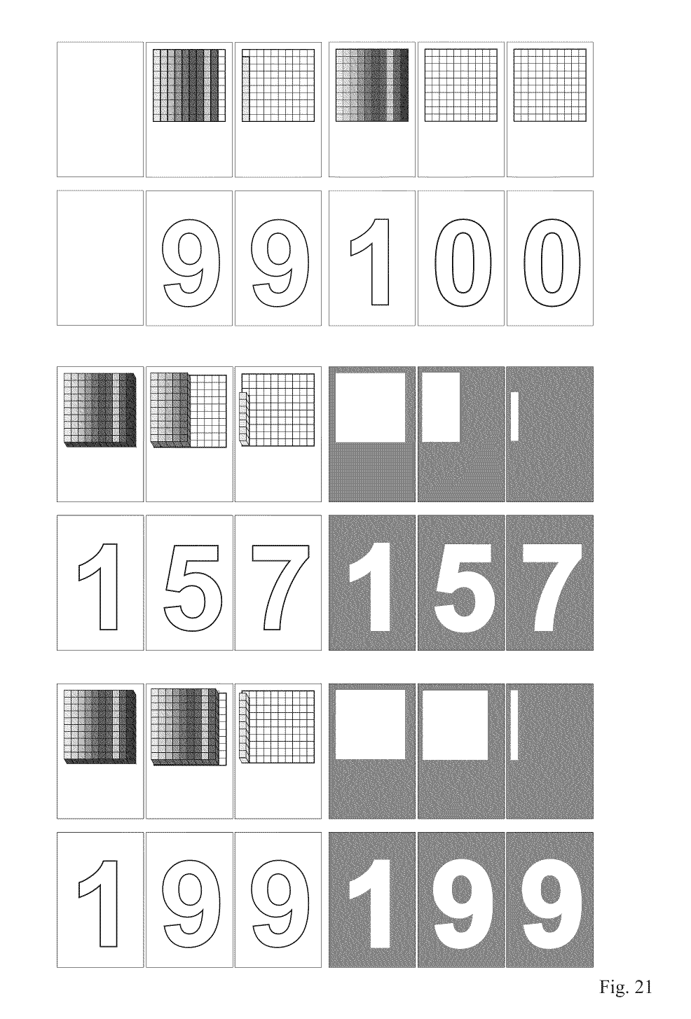

FIG. 21. DECIMAL SYSTEM JIGSAWS, pads for numbers 99 and 100—up; parts arranged on pads for number 157 and the frame for that number—in the middle, and the highest number 199 arranged on the pads and the frame for that number

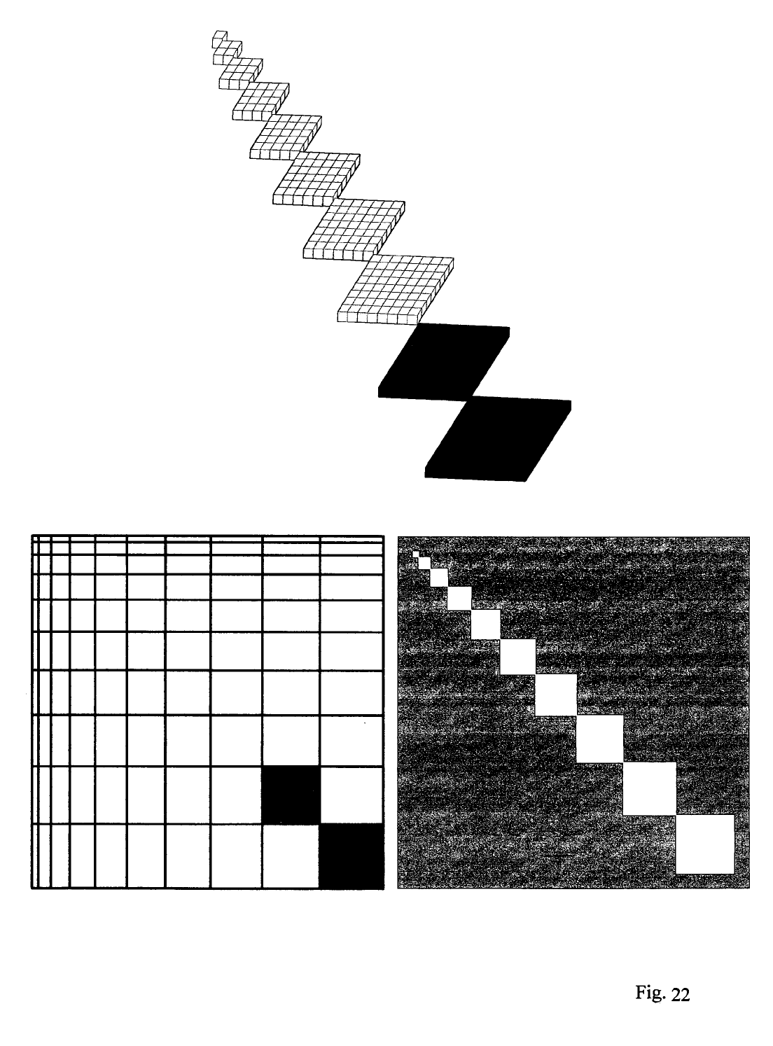

FIG. 22. Parts of the MULTIPLICATION TABLE WITHOUT NUMBERS from the main diagonal—up, transparencies with indicated coloured squares from the main diagonal, and a frame for arranging these parts

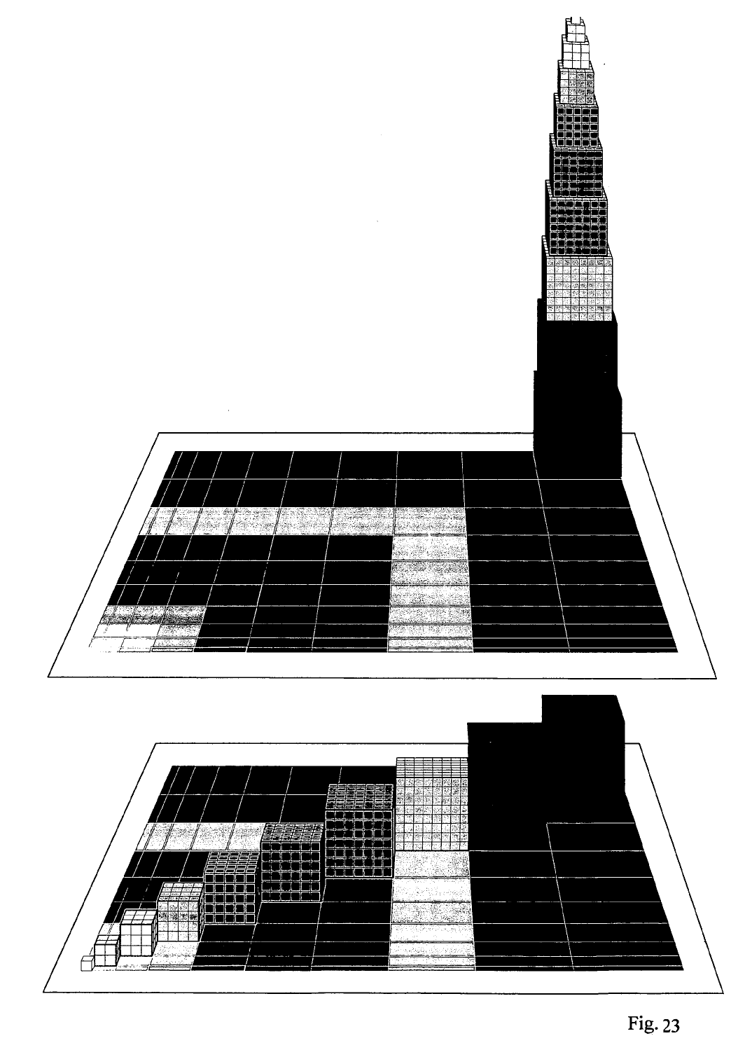

FIG. 23. All parts of the MULTIPLICATION TABLE WITHOUT NUMBERS arranged in CUBES one above the other—up, and all parts arranged in CUBES on the main diagonal squares—down

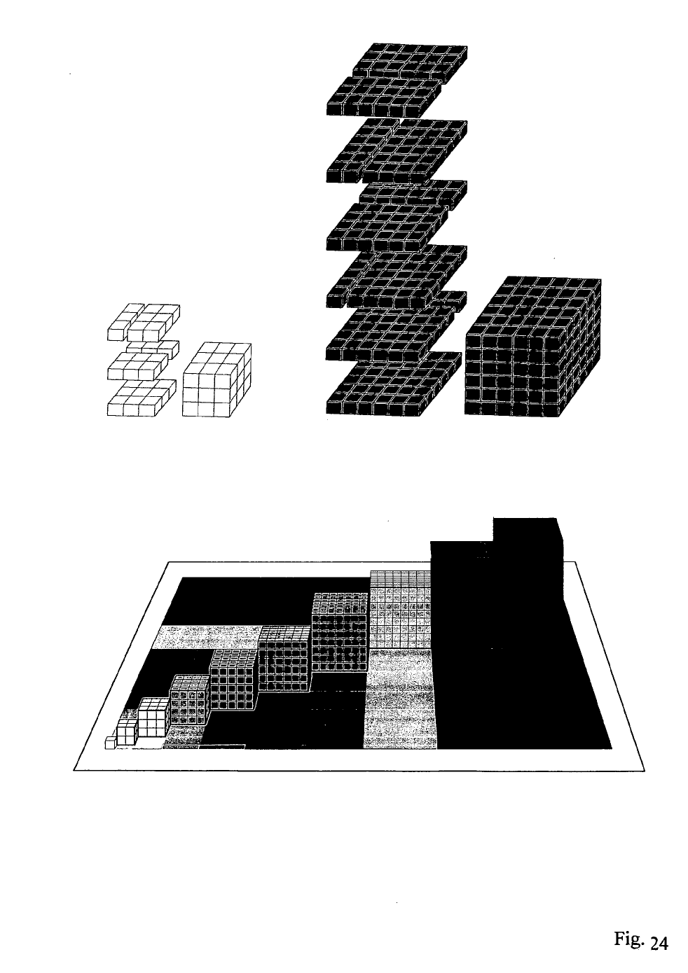

FIG. 24. Display of parts for arranging CUBE 3⁵ and 5³, and all the CUBES on the diagonal

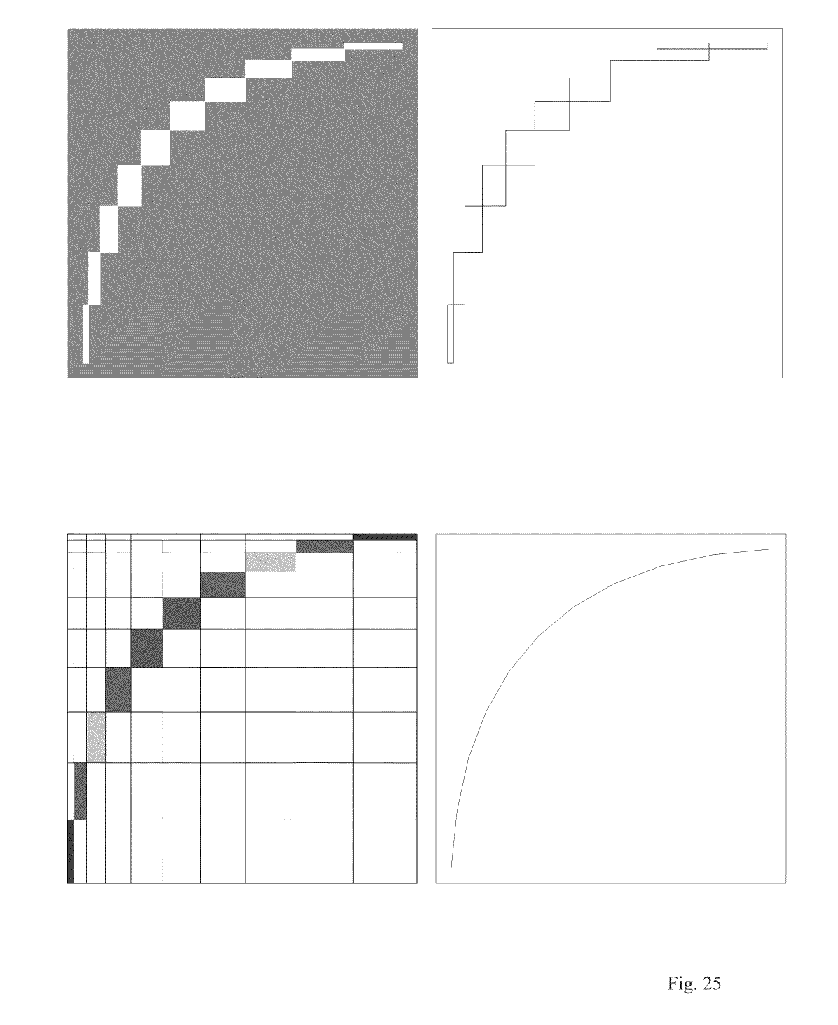

FIG. 25. Frame with empty spaces for arranging the opposite MULTIPLICATION TABLE WITHOUT NUMBERS diagonal, and a transparency with the opposite diagonal space; a transparency with coloured products of multiplication—rectangles and their diagonals

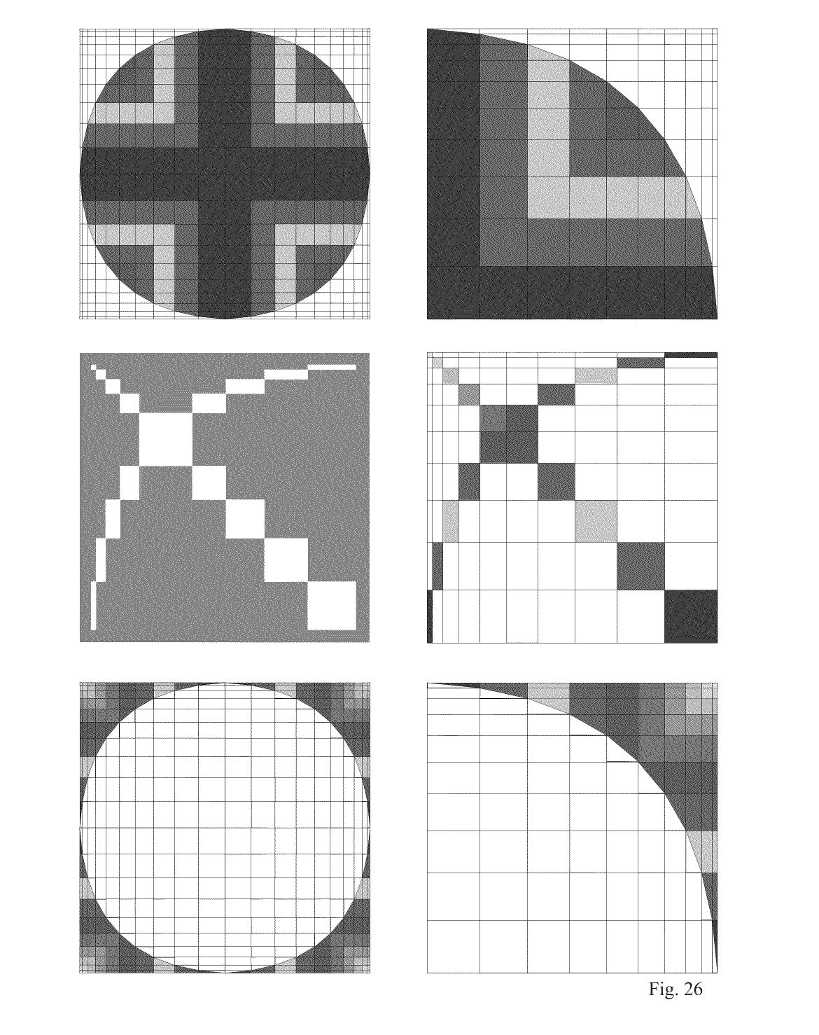

FIG. 26. Transparencies for displaying the SQUARING THE CIRCLE using the MULTIPLICATION TABLE WITHOUT NUMBERS; 4 transparencies arranged symmetrically left-right and up-down, with coloured parts forming a circle and ¼ of a circle—up, and a frame with empty spaces for both diagonals and a coloured transparency for them—down

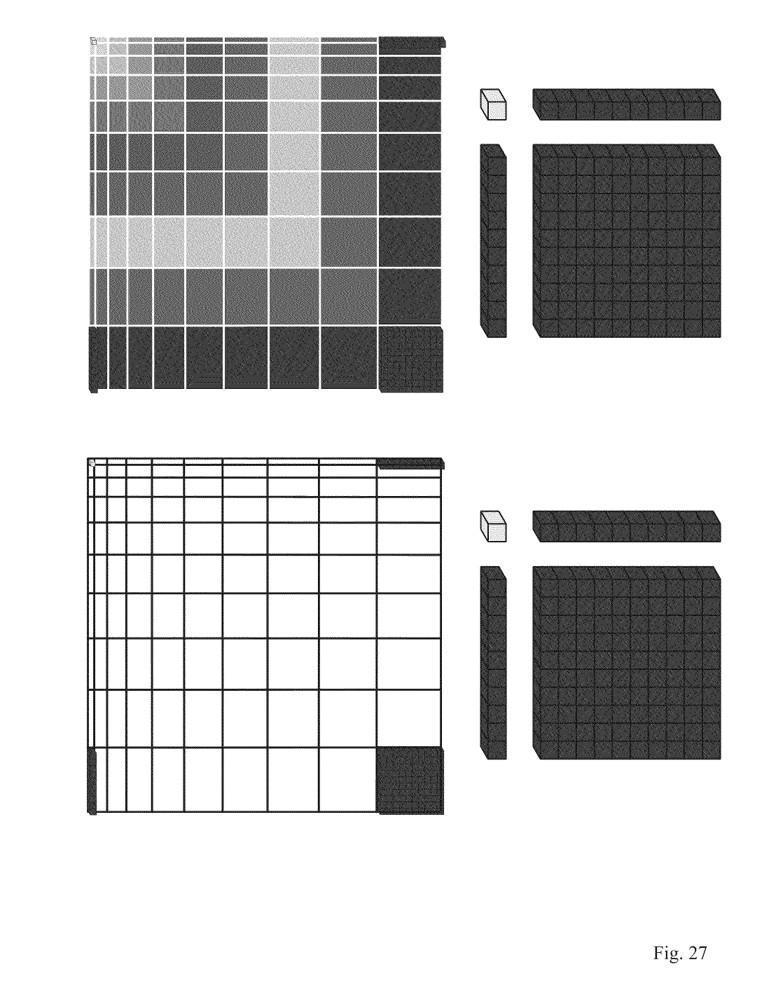

FIG. 27. Transparencies and parts of the MULTIPLICATION TABLE WITHOUT NUMBERS for displaying the binomial theorem—the square of the sum (1+10)² in a new way with a pad, and the parts of the MULTIPLICATION TABLE WITHOUT NUMBERS—up, and with a colourless pad—down

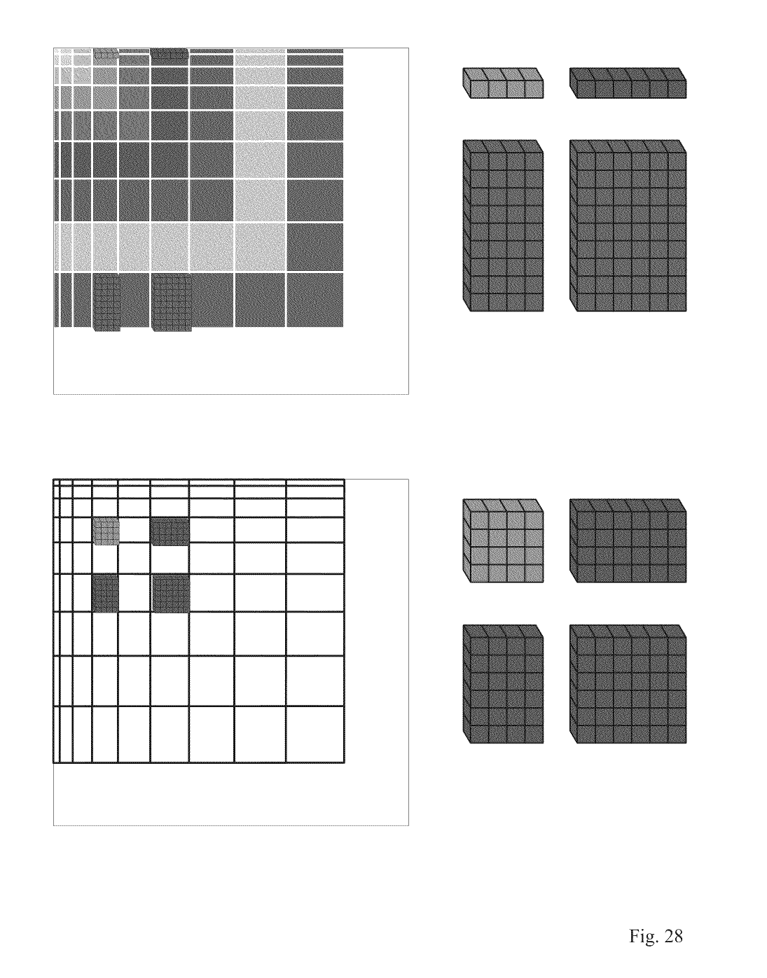

FIG. 28. Binomial theorem, (5+6)², displayed using a pad and the parts of the MULTIPLICATION TABLE WITHOUT NUMBERS in a familiar way: 5²+(2×5×6)+6²—up; and in a new way—down

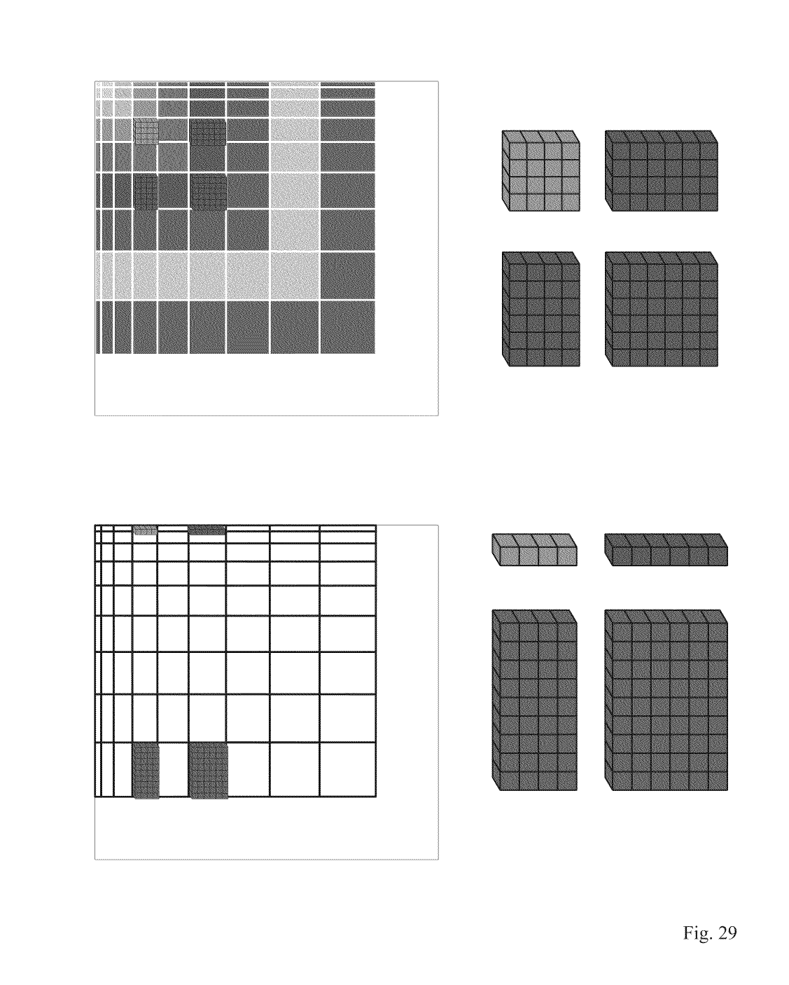

FIG. 29. Binomial theorem, the square of the sum of numbers 4 and 6, displayed using the MULTIPLICATION TABLE WITHOUT NUMBERS in a familiar and a new way

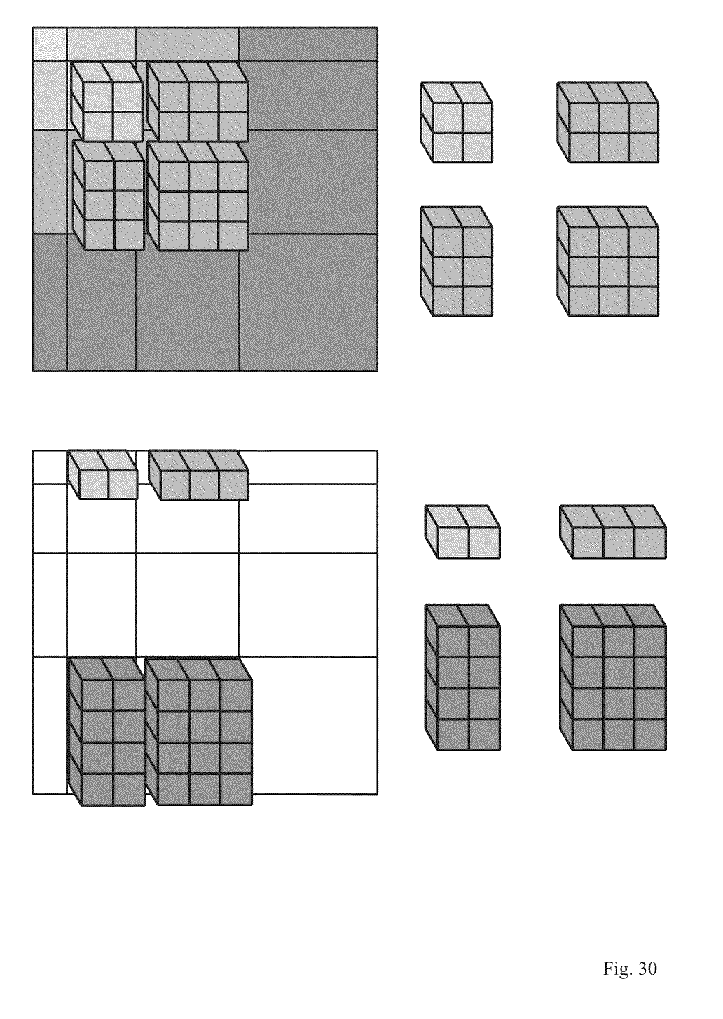

FIG. 30. Binomial theorem, the square of the sum of numbers 2 and 3, displayed using the MULTIPLICATION TABLE WITHOUT NUMBERS in a familiar way—up, and in a new way—down

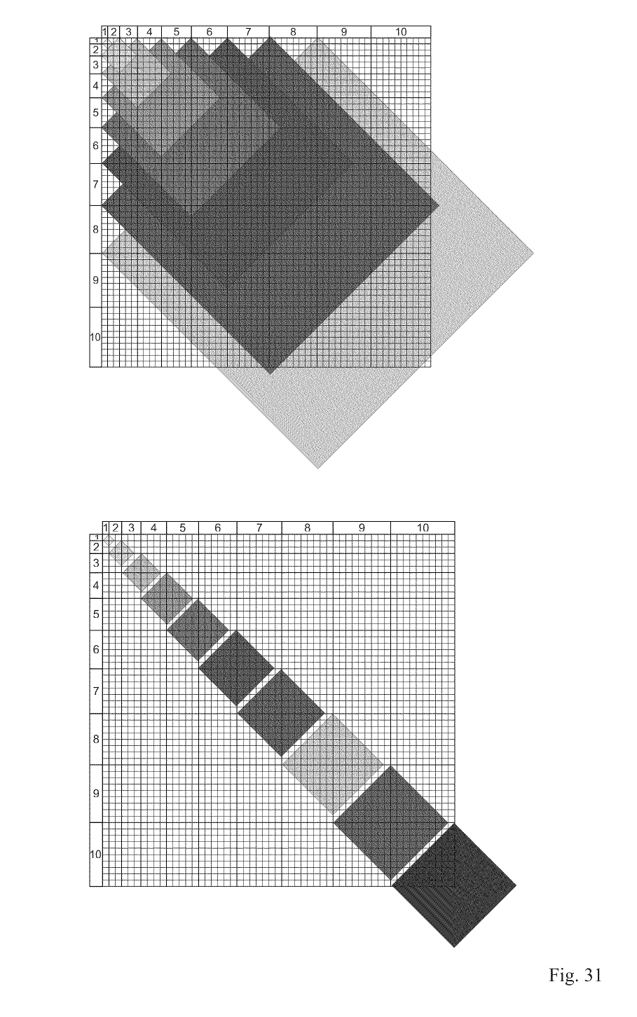

FIG. 31. Pitagora's theorem, squares over the hypotenuse displayed using coloured transparencies and a colourless MULTIPLICATION TABLE WITHOUT NUMBERS pad for the kathets sized 1; 1+2: 1+2+3; till 1+2+3+4+5+6+7+8 in a row—up, and the squares over the hypotenuses of the triangle for the kathets sized from 1 to 10 in a row on the same pad

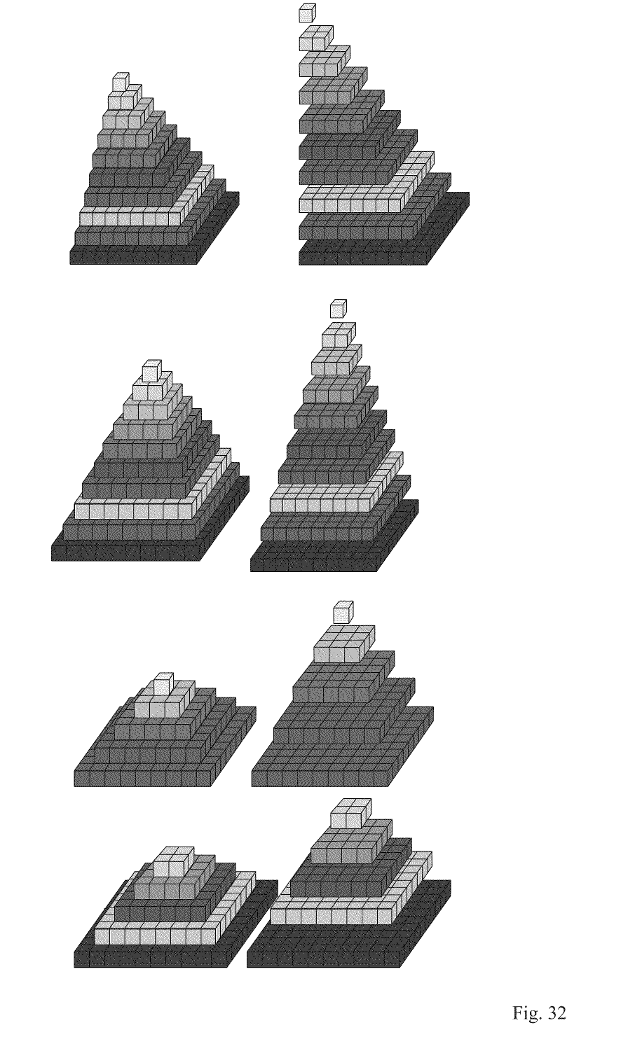

FIG. 32. Square sequences jigsaw of numbers from 1 to 10 arranged in an angle—the first row; arranged centrally—the second row; the squares of odd numbers—third row, and of even numbers—the fourth row

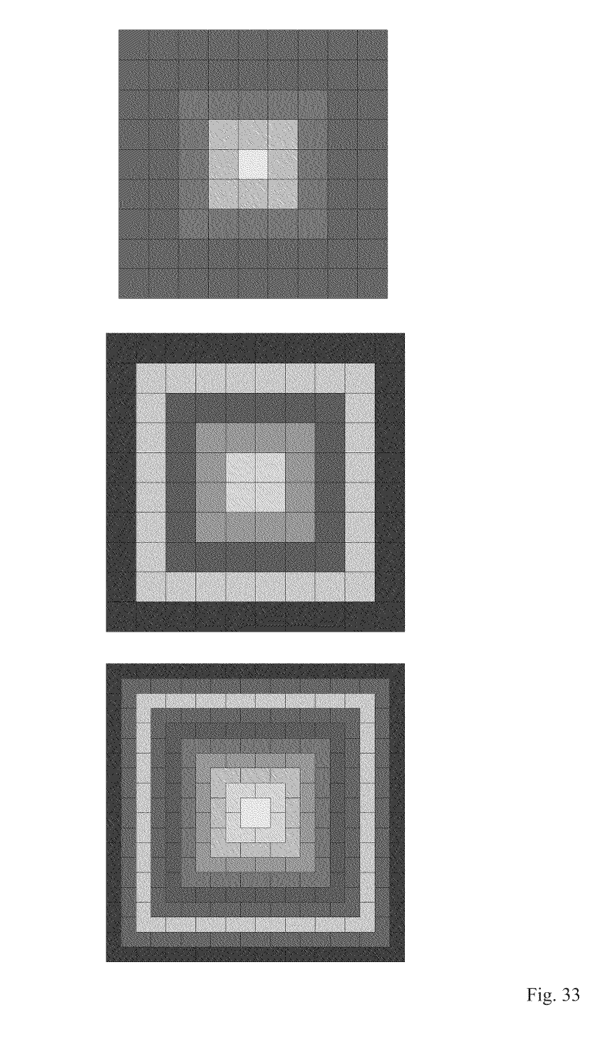

FIG. 33. Sum layouts of square sequences for odd and even numbers and the squares of numbers from 1 to 10

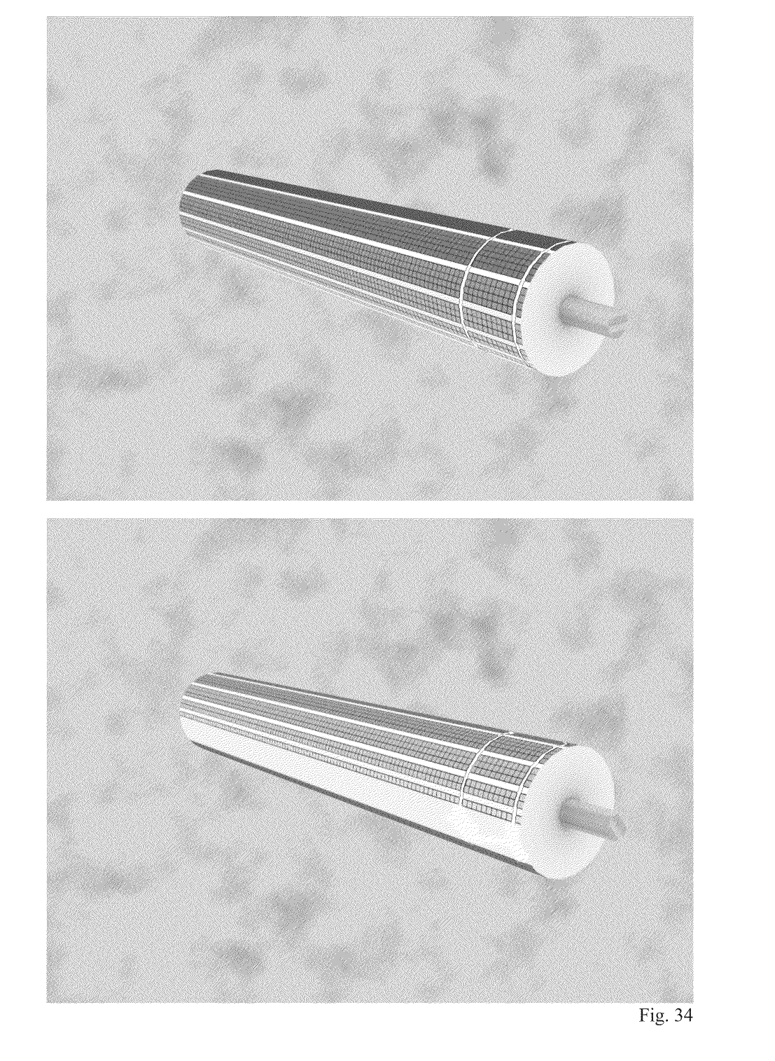

FIG. 34. The DECIMAL SYSTEM JIGSAW AND THE POSITIONAL NOTATION OF NUMBERS—CYLINDERS

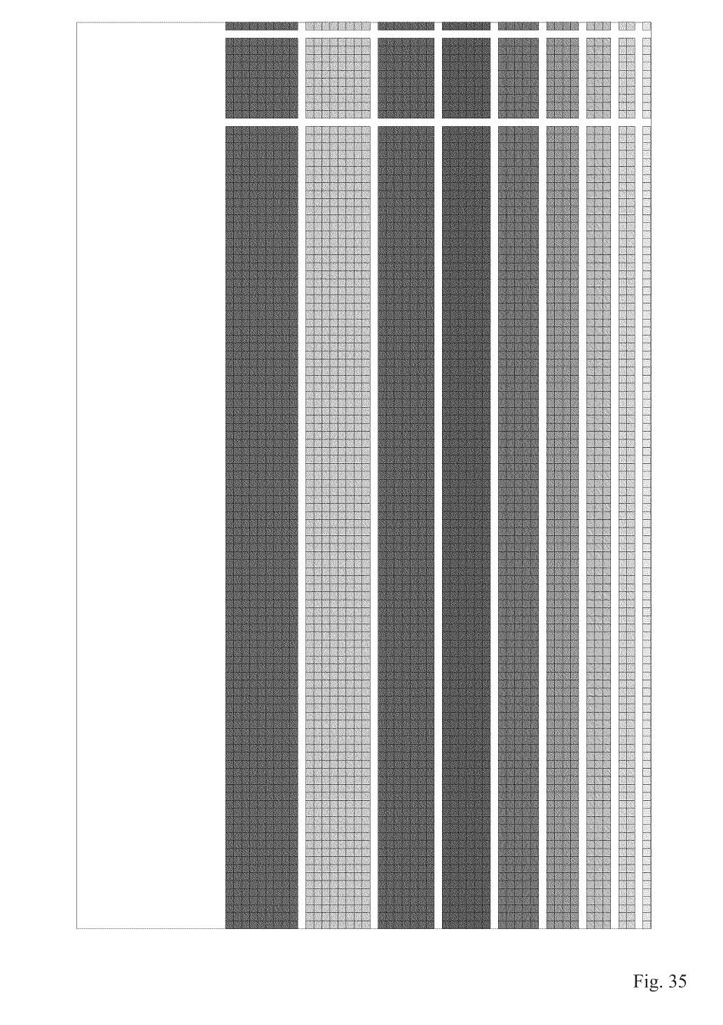

FIG. 35. CYLINDER sheets in position for numbers 111; 222; 333, till 999

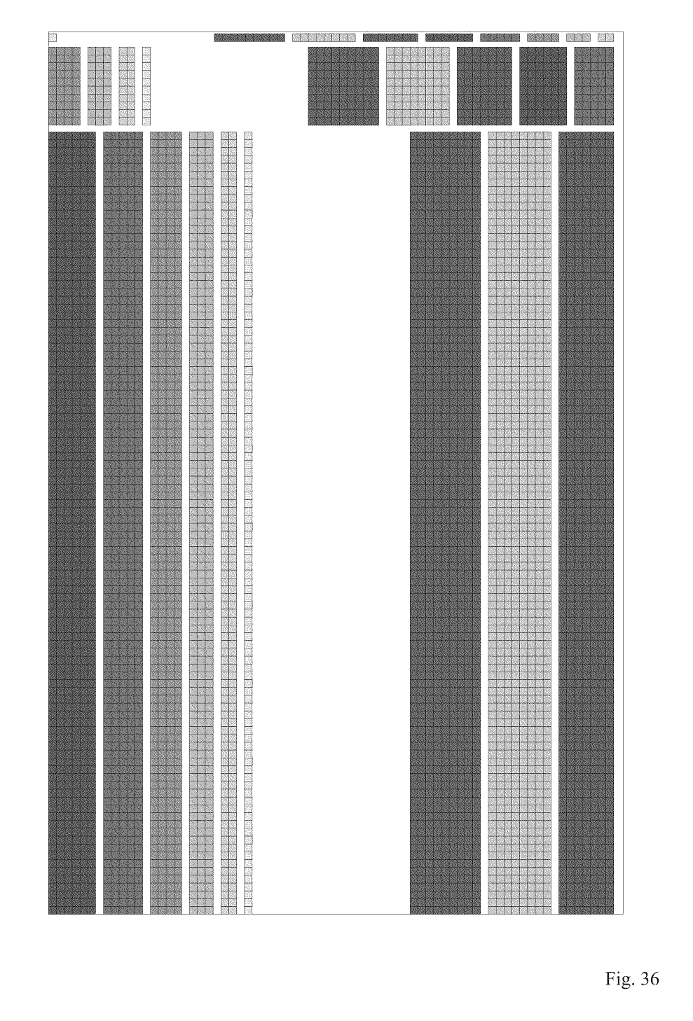

FIG. 36. CYLINDER sheets in position for number with 7 hundreds, 5 tens and 2 ones

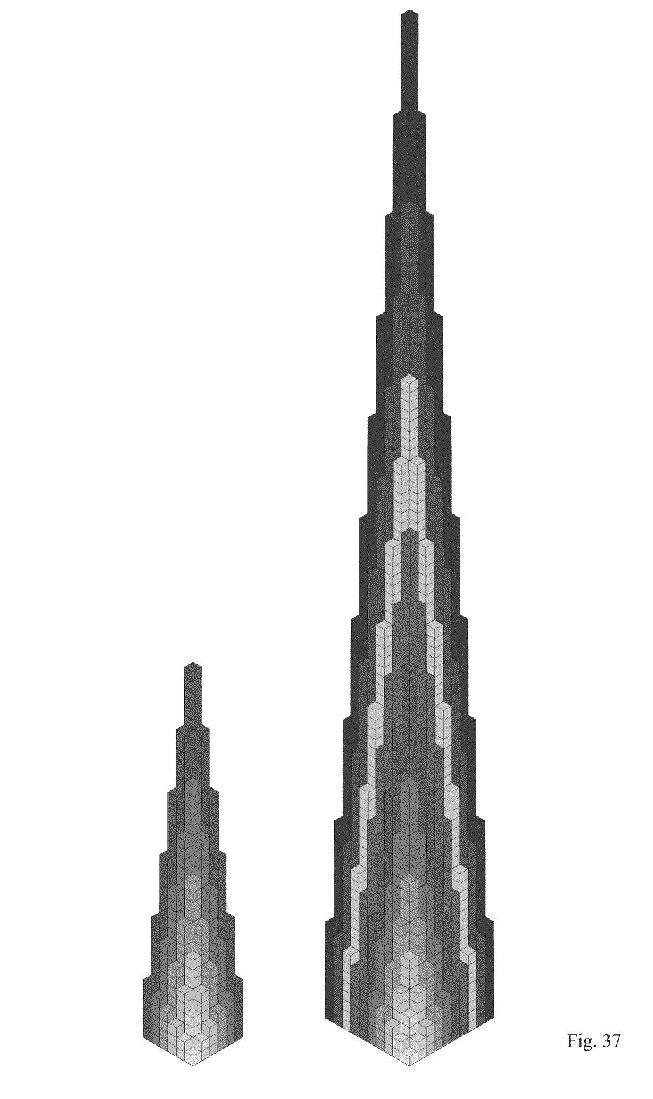

FIG. 37. The MULTIPLICATION TABLE IN HEIGHT, arranged products of multiplication of numbers from 1 to 6 and from 1 to 10

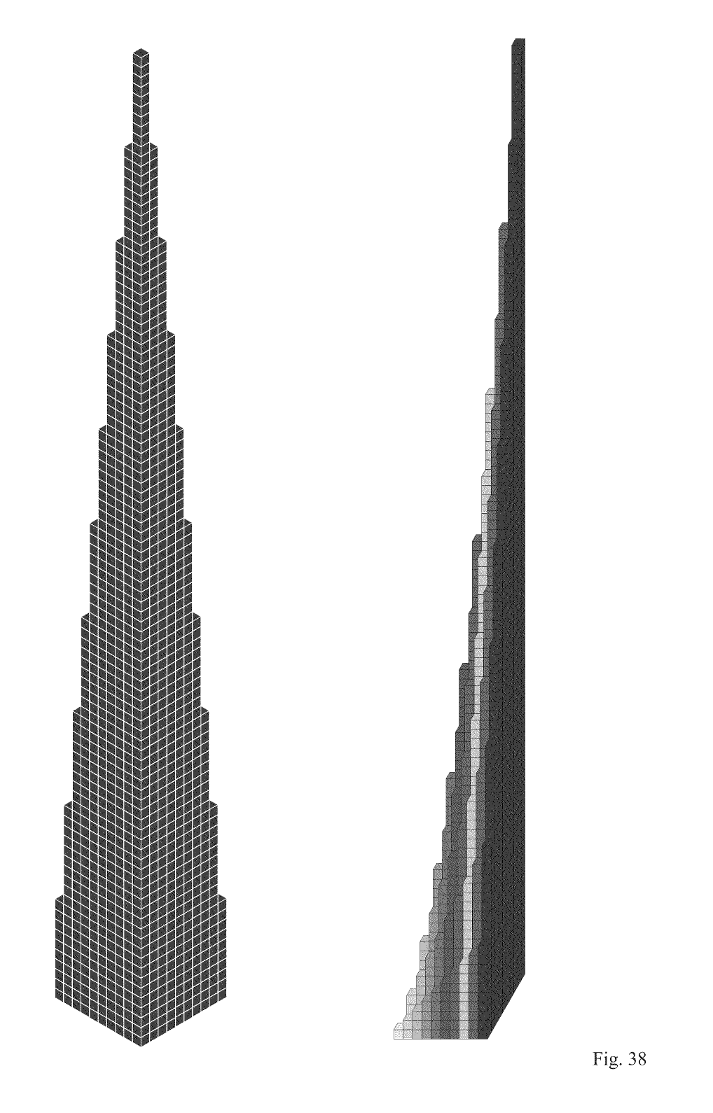

FIG. 38. The MULTIPLICATION TABLE IN HEIGHT from the back—left, and from the side—right

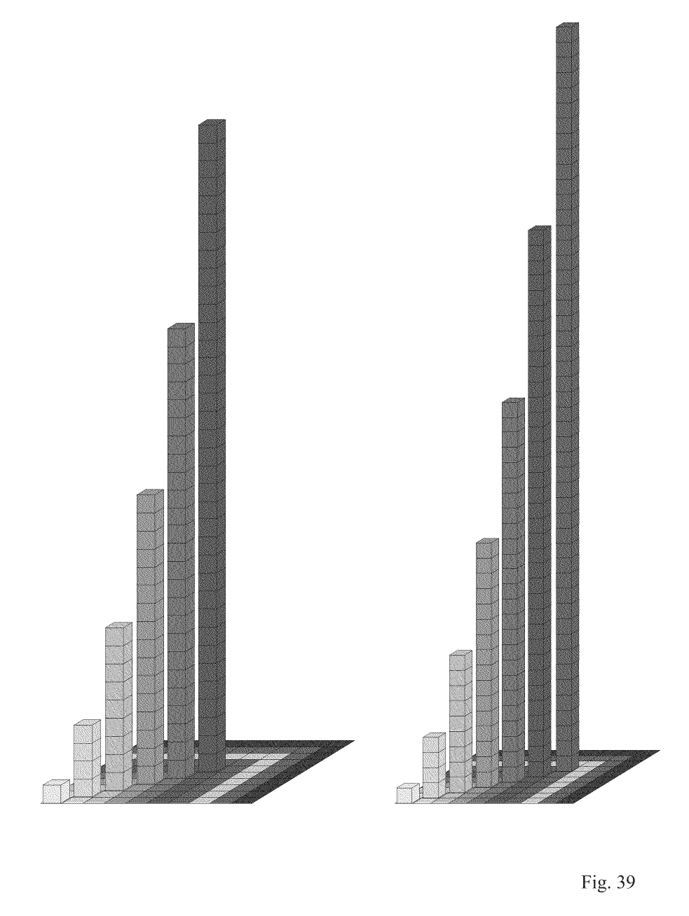

FIG. 39. Parts of the MULTIPLICATION TABLE IN HEIGHT, showing the products of multiplication of numbers with themselves from 1 to 6, and from 1 to 7

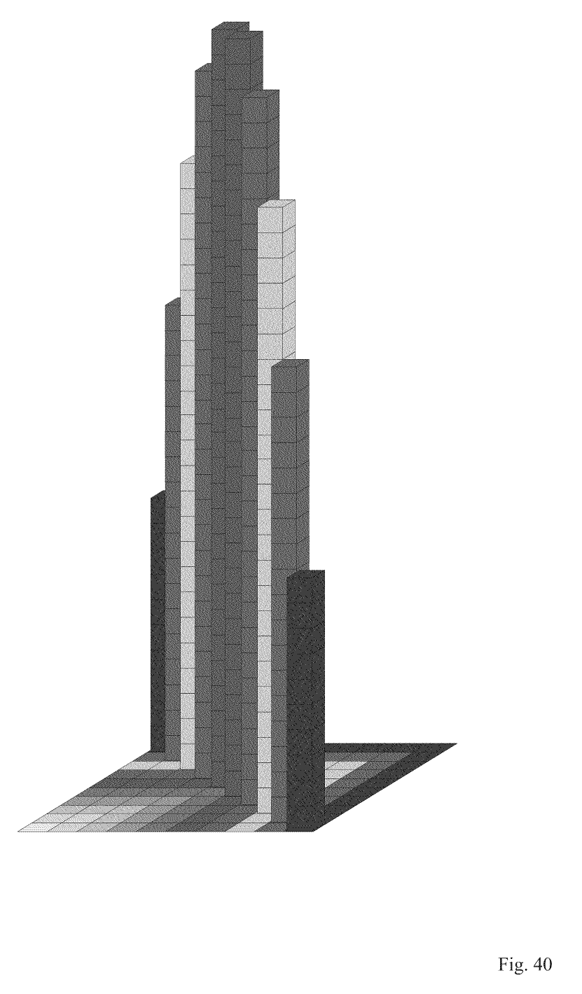

FIG. 40. Parts on the opposite diagonal of the MULTIPLICATION TABLE IN HEIGHT

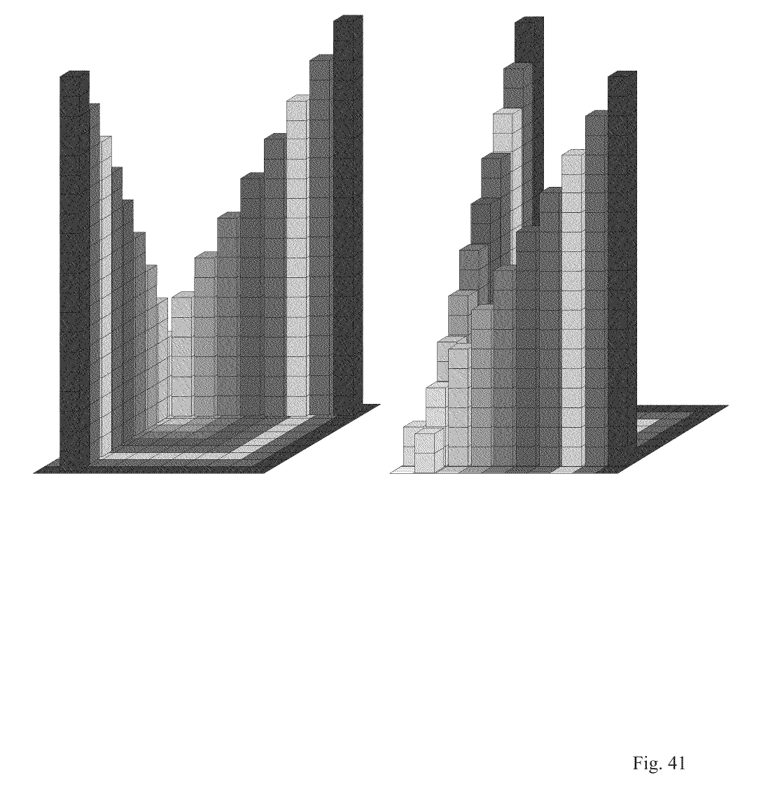

FIG. 41. All products of multiplication of number 2 of the MULTIPLICATION TABLE IN HEIGHT, observed from two sides

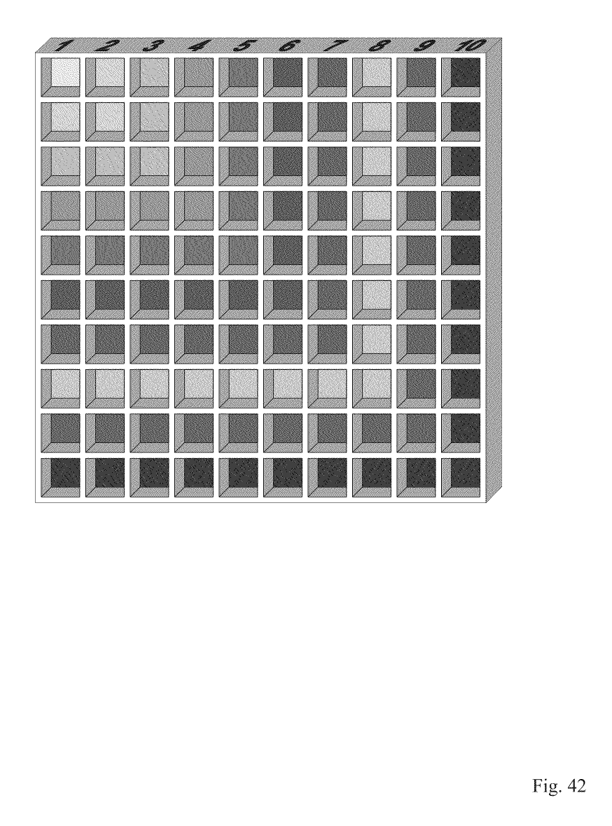

FIG. 42. Space for arranging of the 100 CUBES MULTIPLICATION TABLE with a basic coloured pad

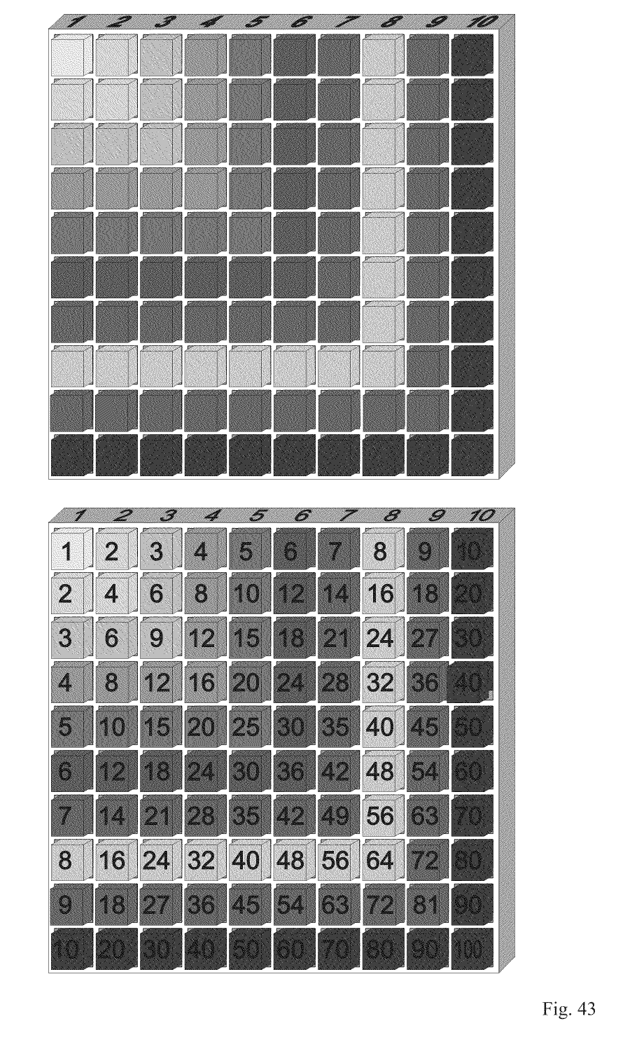

FIG. 43. Cubes of the 100 CUBES MULTIPLICATION TABLE, arranged only according to colour—up; and products of multiplication—down

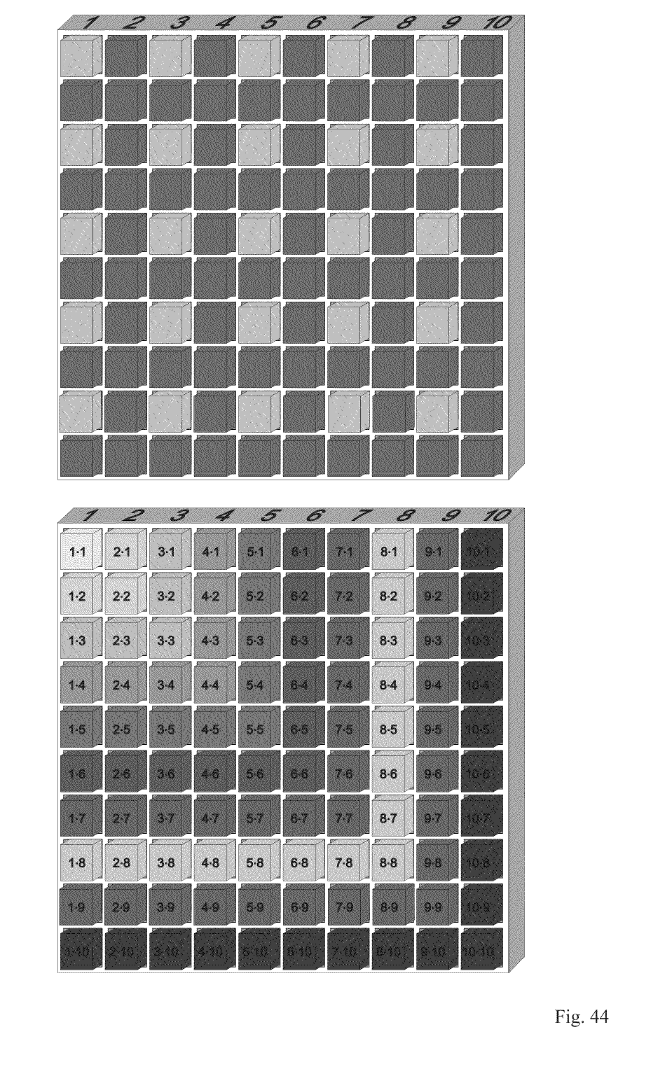

FIG. 44. Cubes of the 100 CUBES MULTIPLICATION TABLE for odd and even numbers of the factor tables

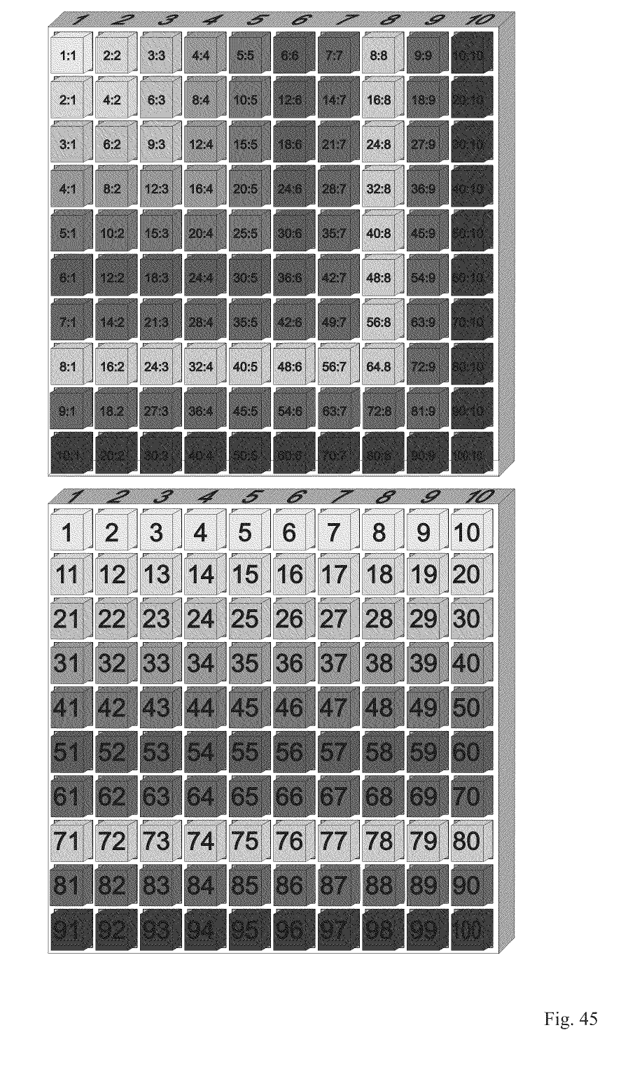

FIG. 45. Cubes of the 100 CUBES MULTIPLICATION TABLE, a division table and a table of ordinal numbers

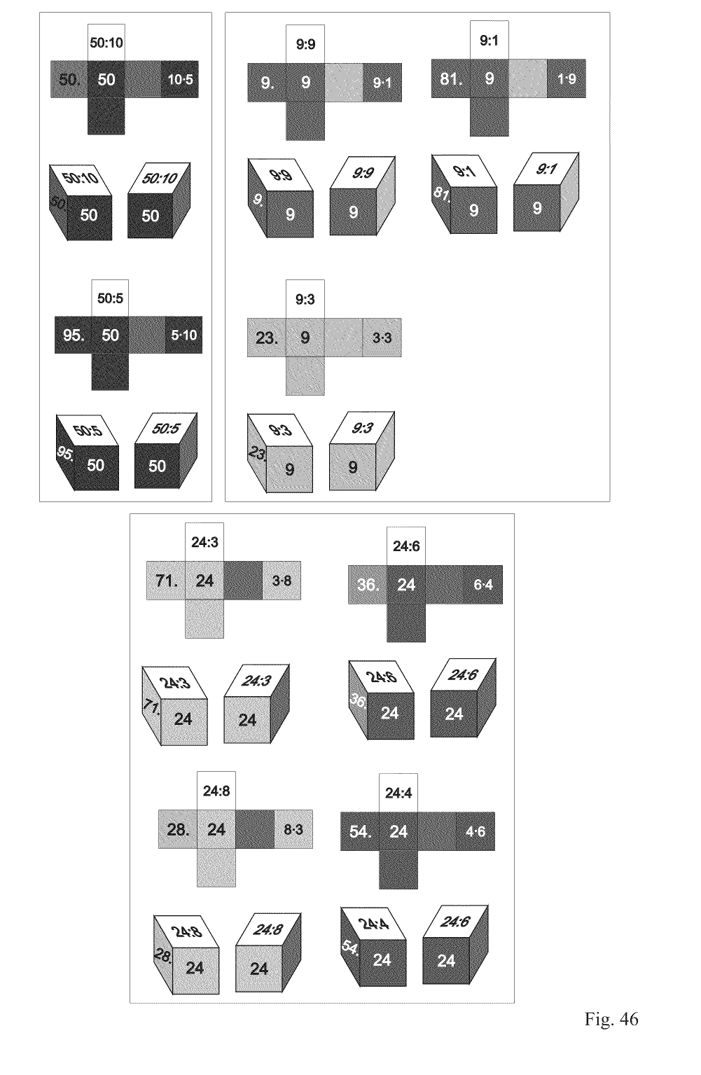

FIG. 46. Volumes of cubes, two products of multiplication of number 50; three products of multiplication of number 9, and four products of multiplication of number 24

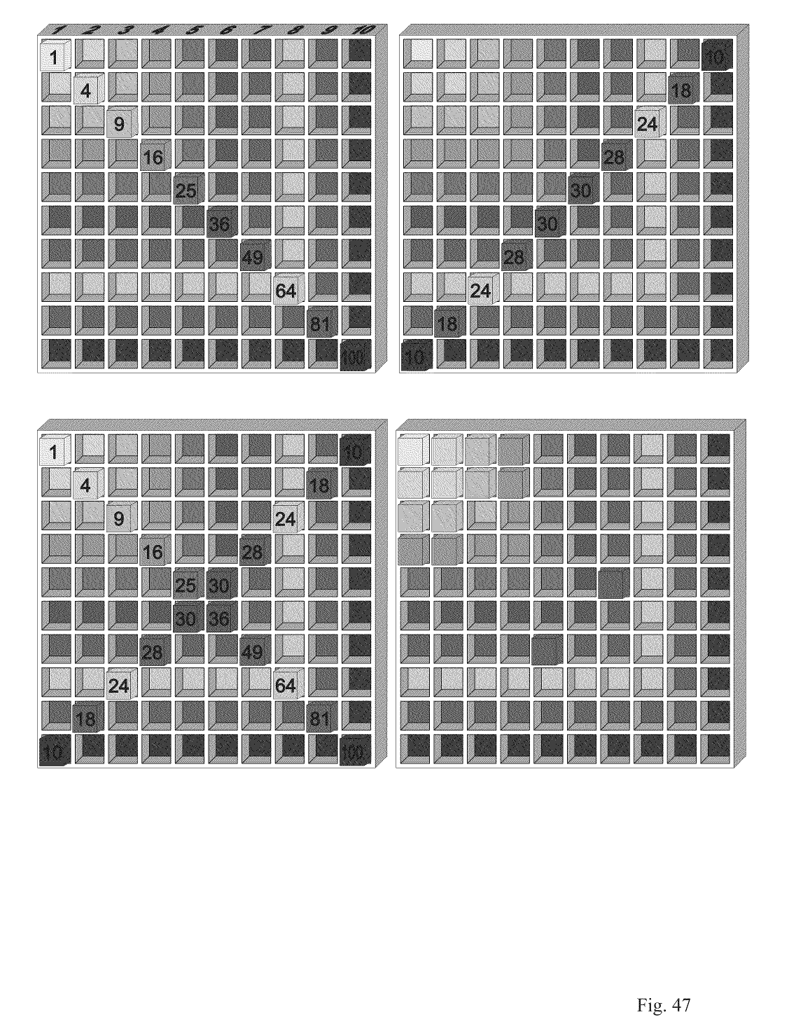

FIG. 47. Cubes of the 100 CUBES MULTIPLICATION TABLE arranged in several variants

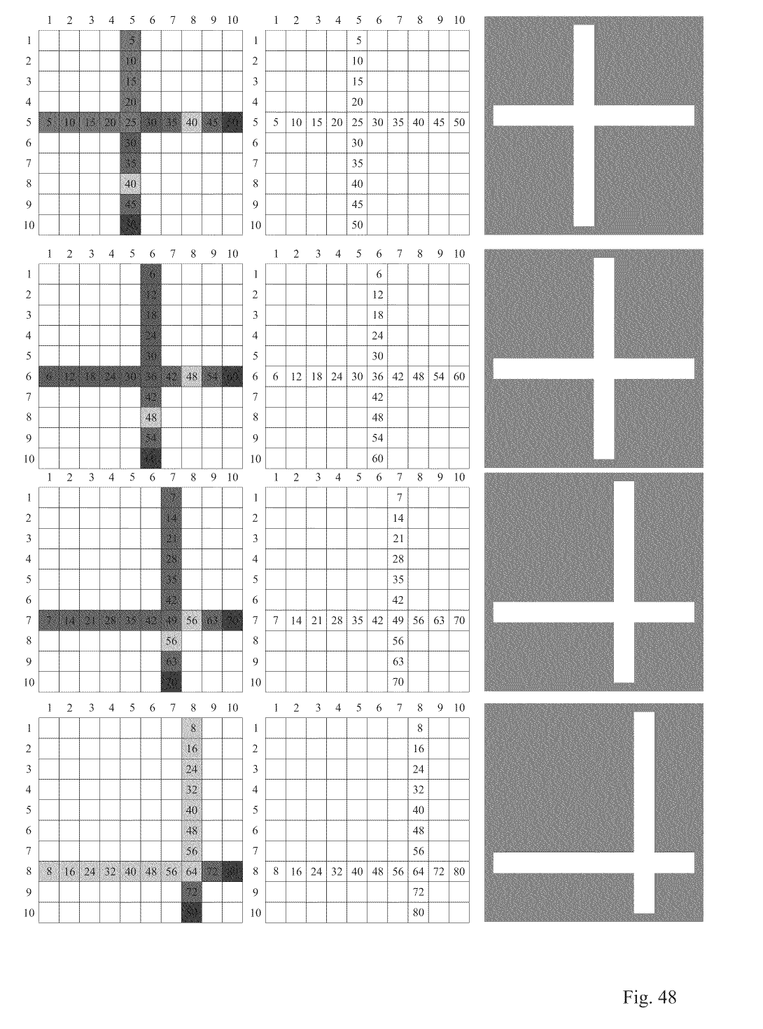

FIG. 48. Coloured transparencies with products of multiplication 5, 6, and 7; colourless transparencies, and a frame for arranging these products of multiplication

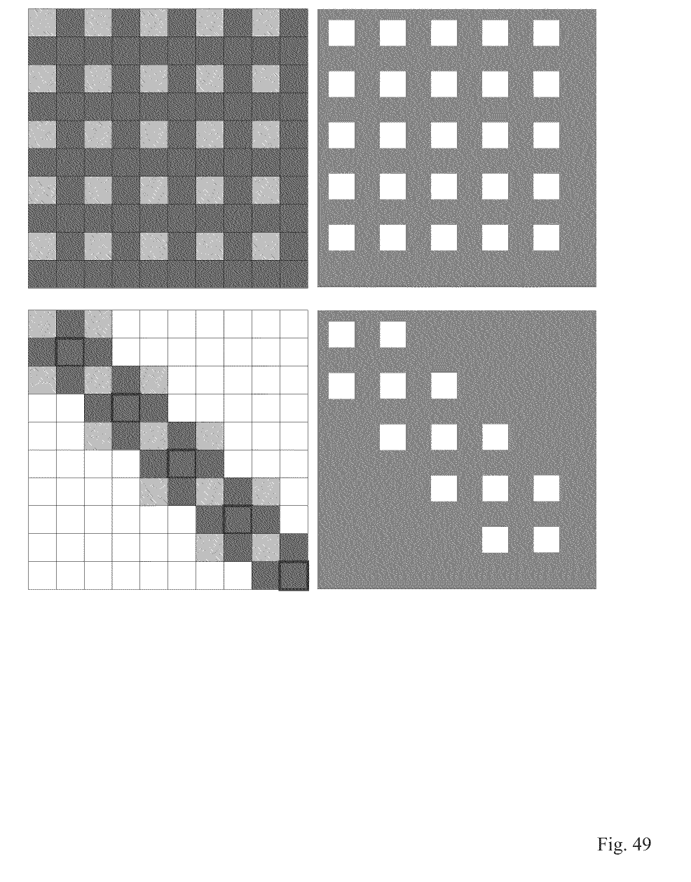

FIG. 49. Coloured transparencies with displays of odd and even products, and frames for the odd products of multiplication

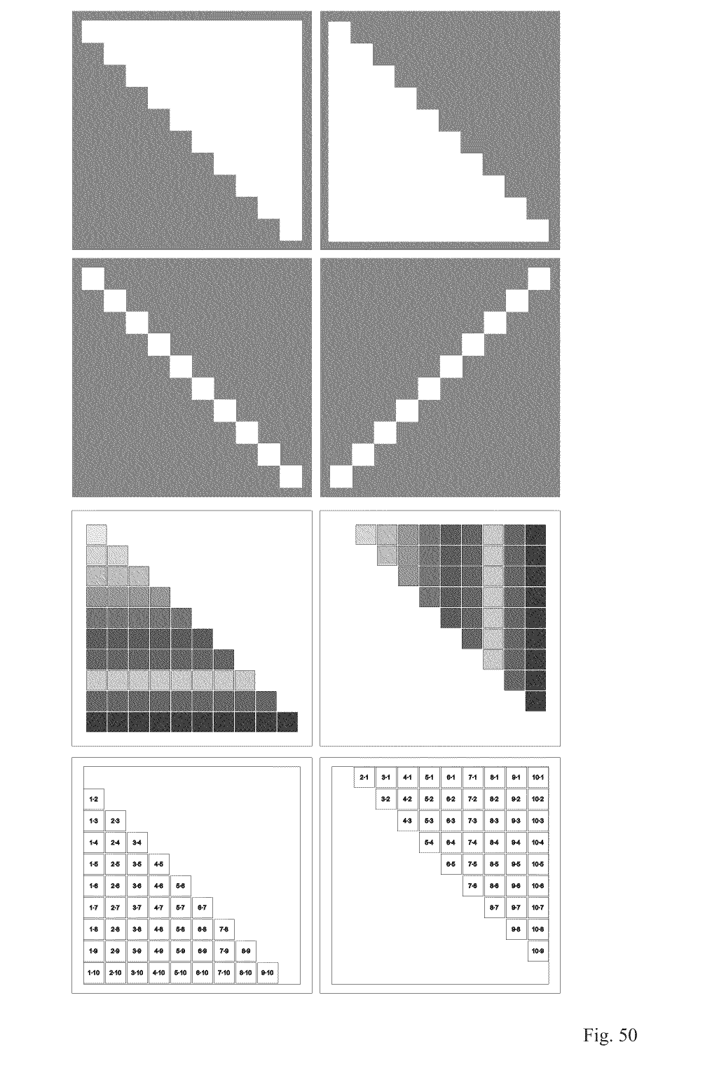

FIG. 50. 4 frames and 4 transparencies for arranging the 100 CUBES MULTIPLICATION TABLE parts

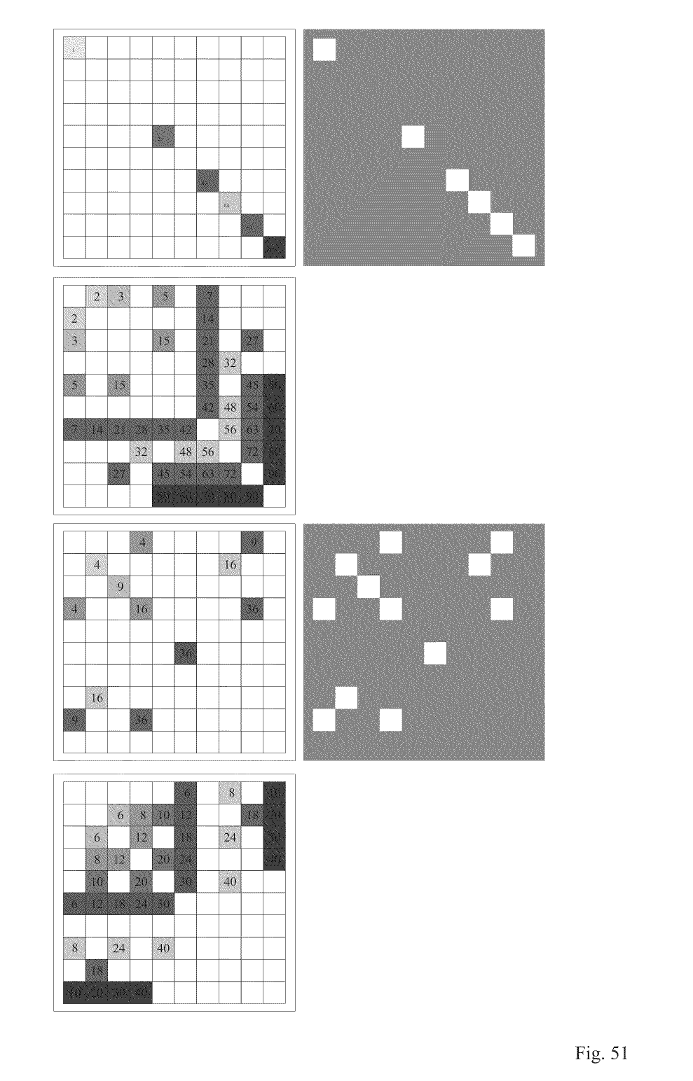

FIG. 51. Transparencies for products of multiplication appearing in the table once; twice; three and four times—left, and frames for arranging the products of multiplication—right

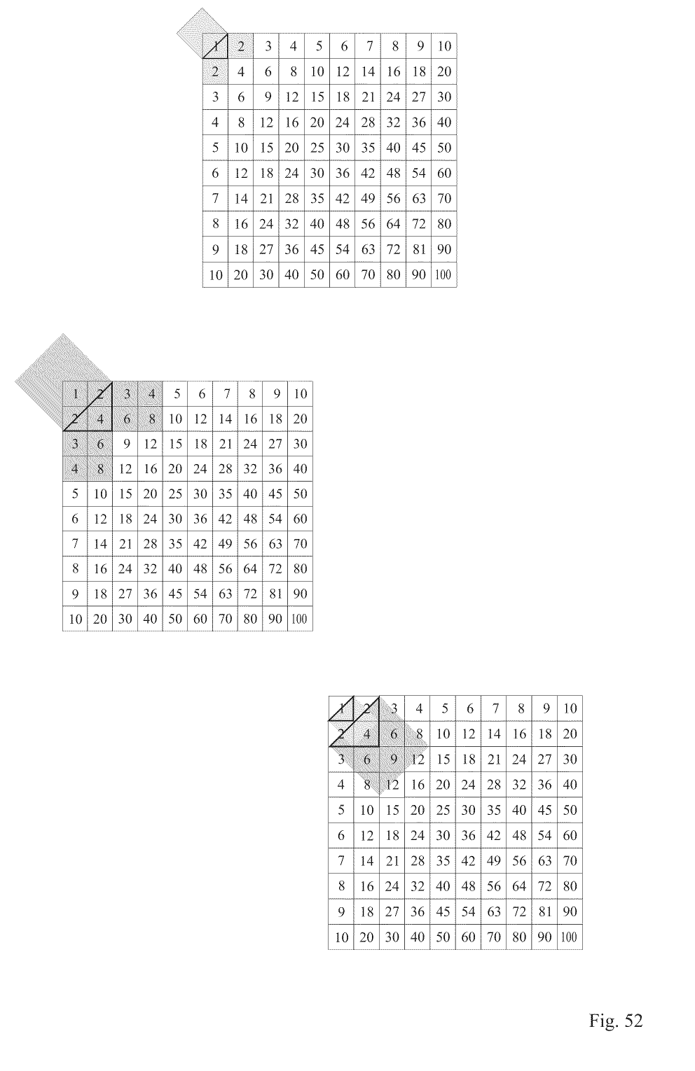

FIG. 52. Pitagora's theorem with transparencies for triangles with kathets 1 and 2 in a familiar way, and a display of the square over the hypotenuse over a triangle with a pad

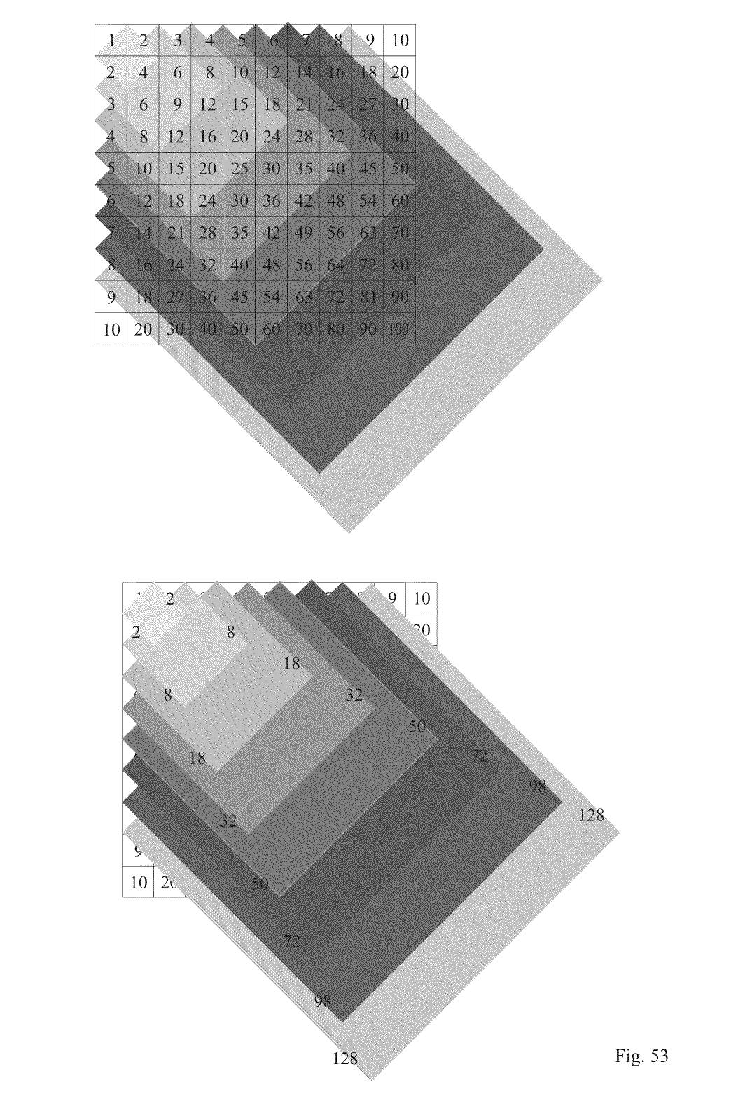

FIG. 53. Display of the squares over the hypotenuse of an isosceles triangle with kathets from 1 to 8 in a sequence on a colourless product of multiplication table (up), and the display of the same, only with numbers showing the square size

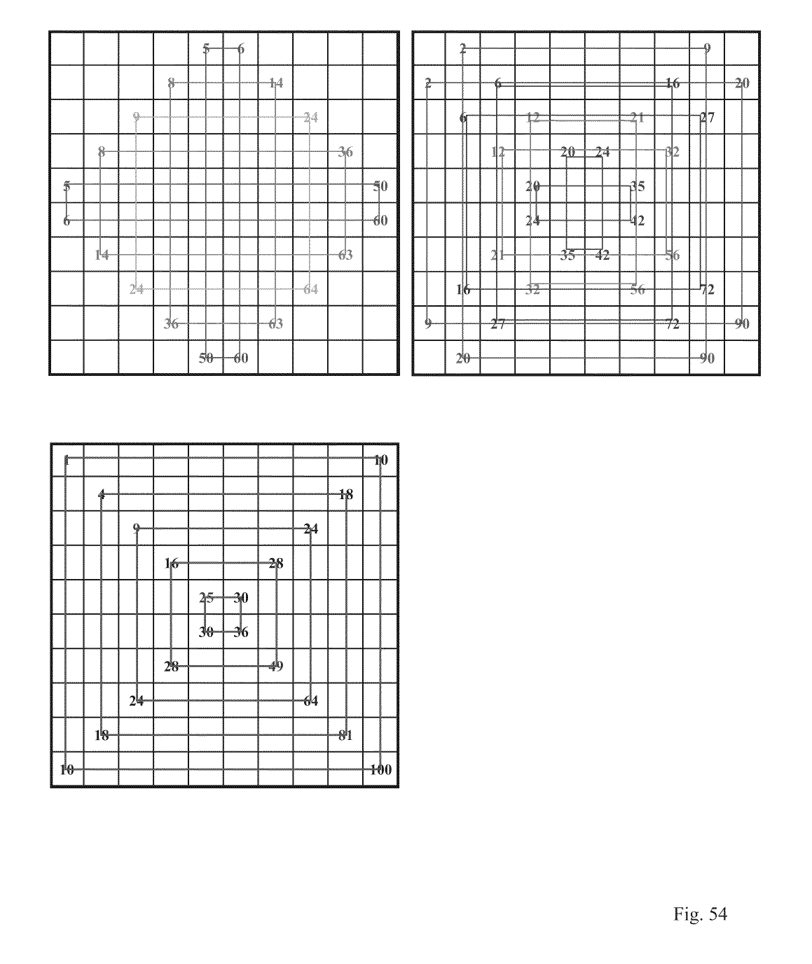

FIG. 54. Display of the binomial theorem of the squares of the sums of numbers 1+10, or 5+6, and other examples for 11². The adding numbers giving a result are connected by lines of the same colour in form of a square and a rectangle

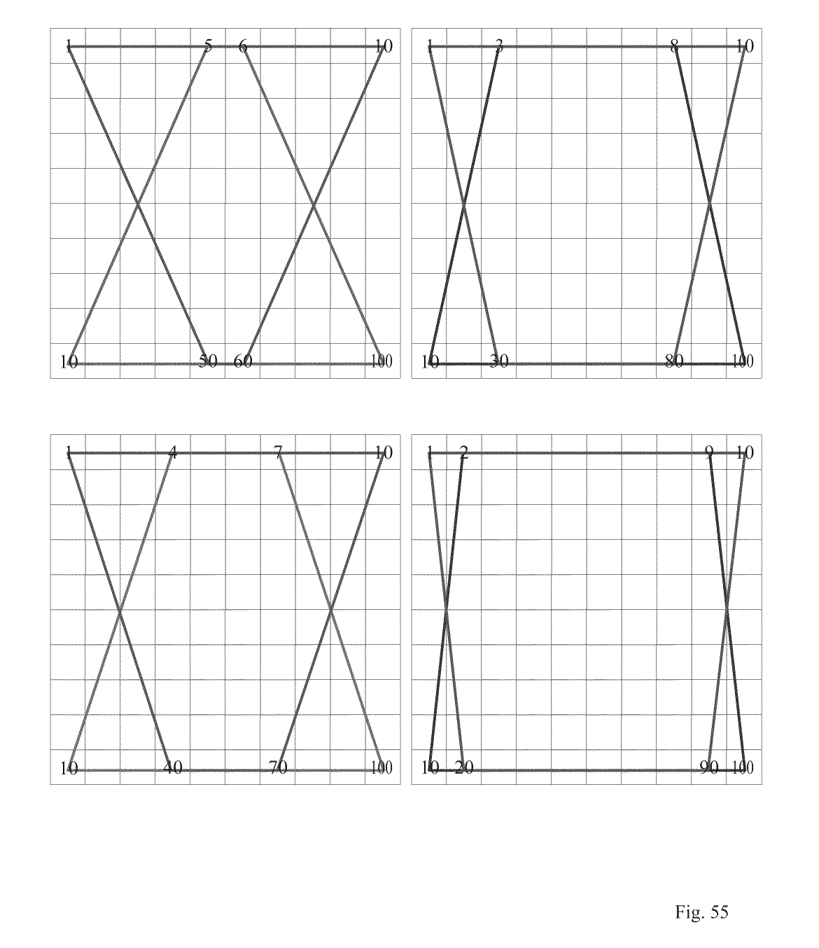

FIG. 55. Display of the binomial theorem of the squares of the sum, using lines connecting the numbers that are added in a trapezoidal manner

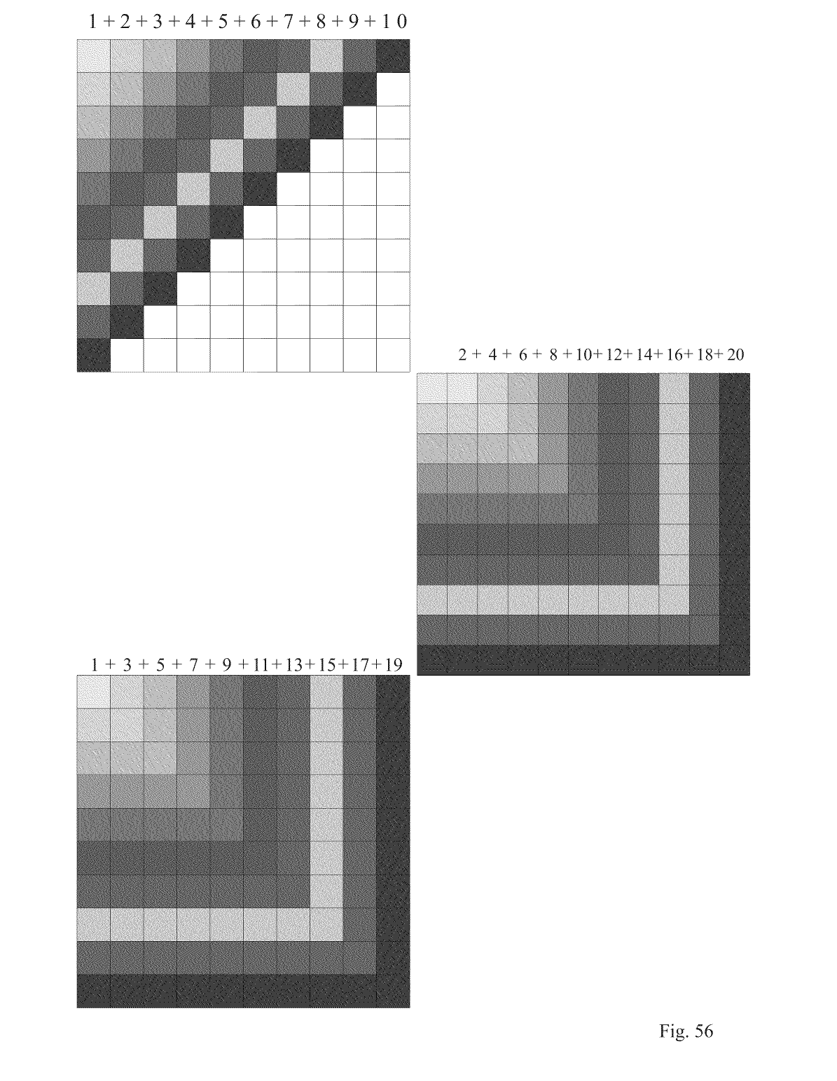

FIG. 56. Display of the sum of number SEQUENCES from 1 to 10; the even ones from 2 to 20, and the odd ones from 1 to 19, using the 100 CUBES MULTIPLICATION TABLE cubes

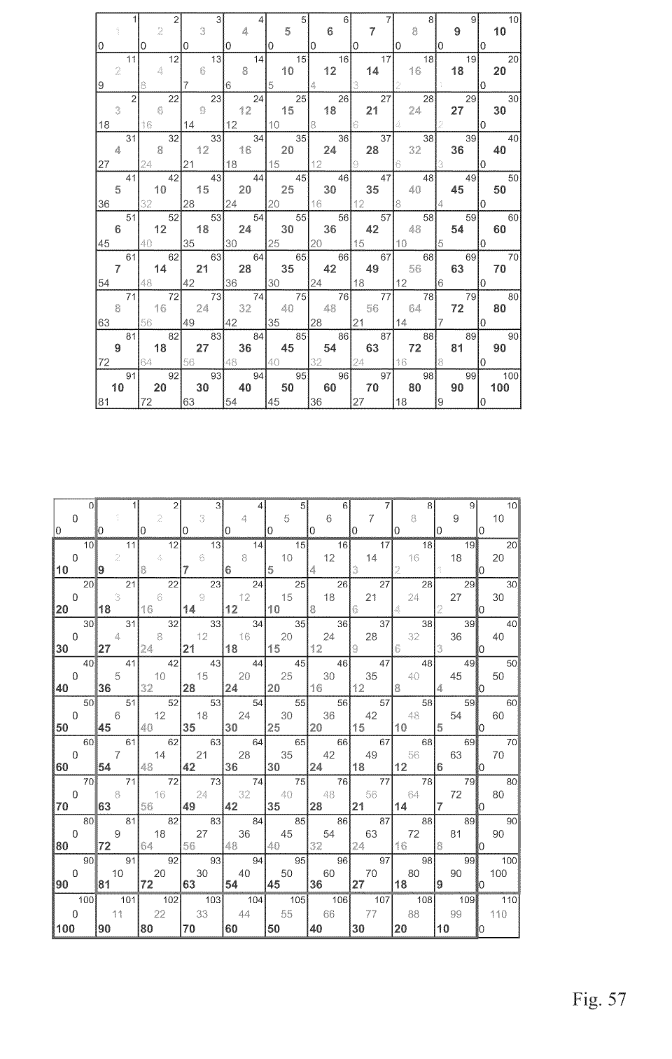

FIG. 57. Transparencies of the ordinal number table and the product of multiplication table for the display of the two-way rotational table

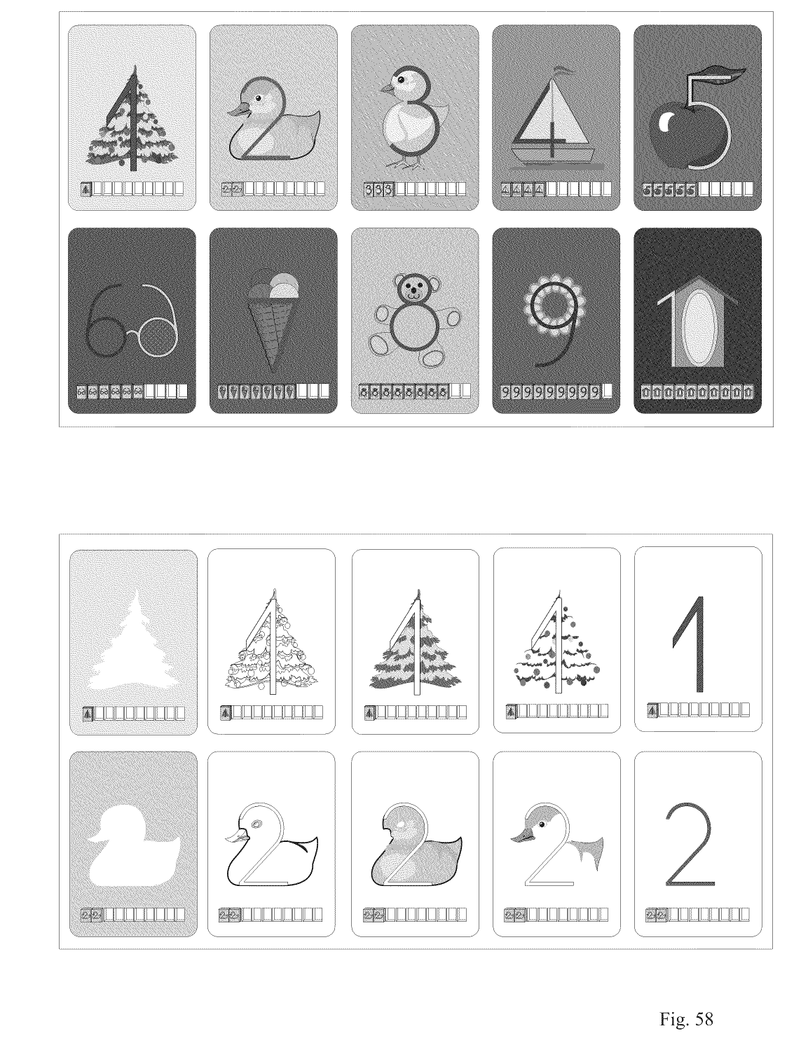

FIG. 58. Transparencies for symbols—figures, a complete picture—up, and partial data—down

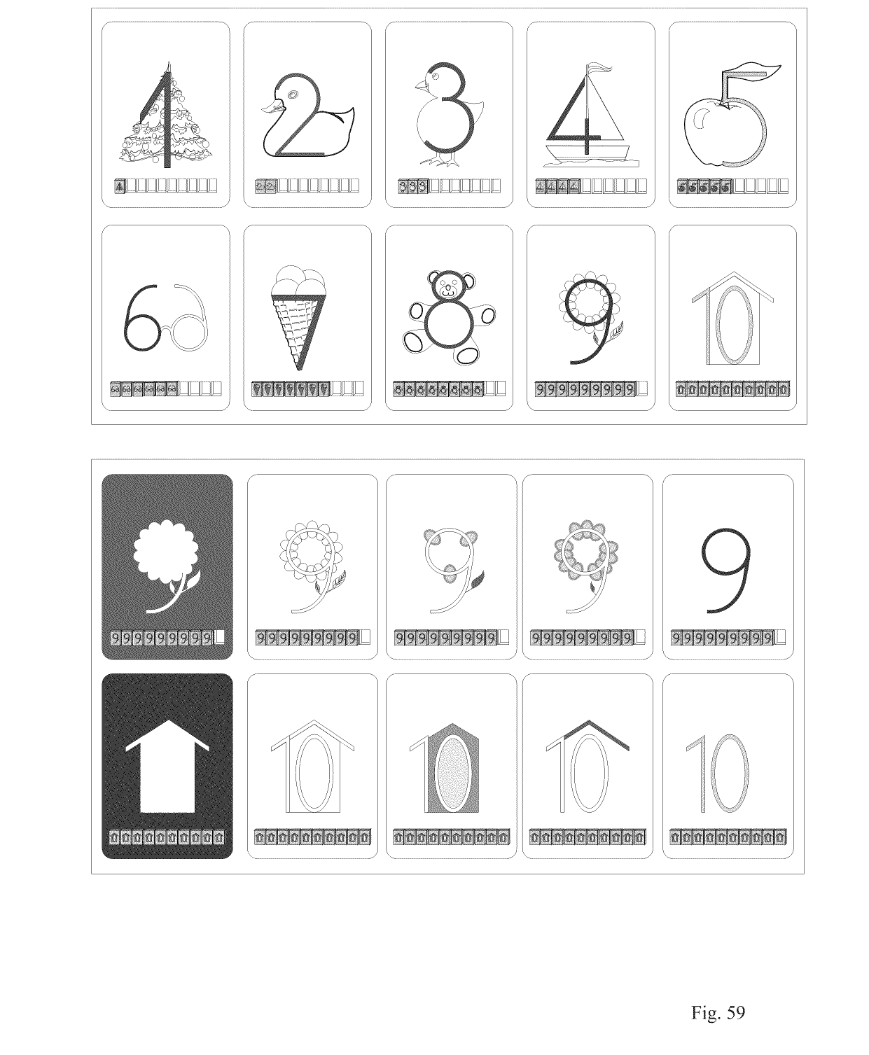

FIG. 59. Transparencies—variants of the partial data for numbers 1 and 2; 9 and 10

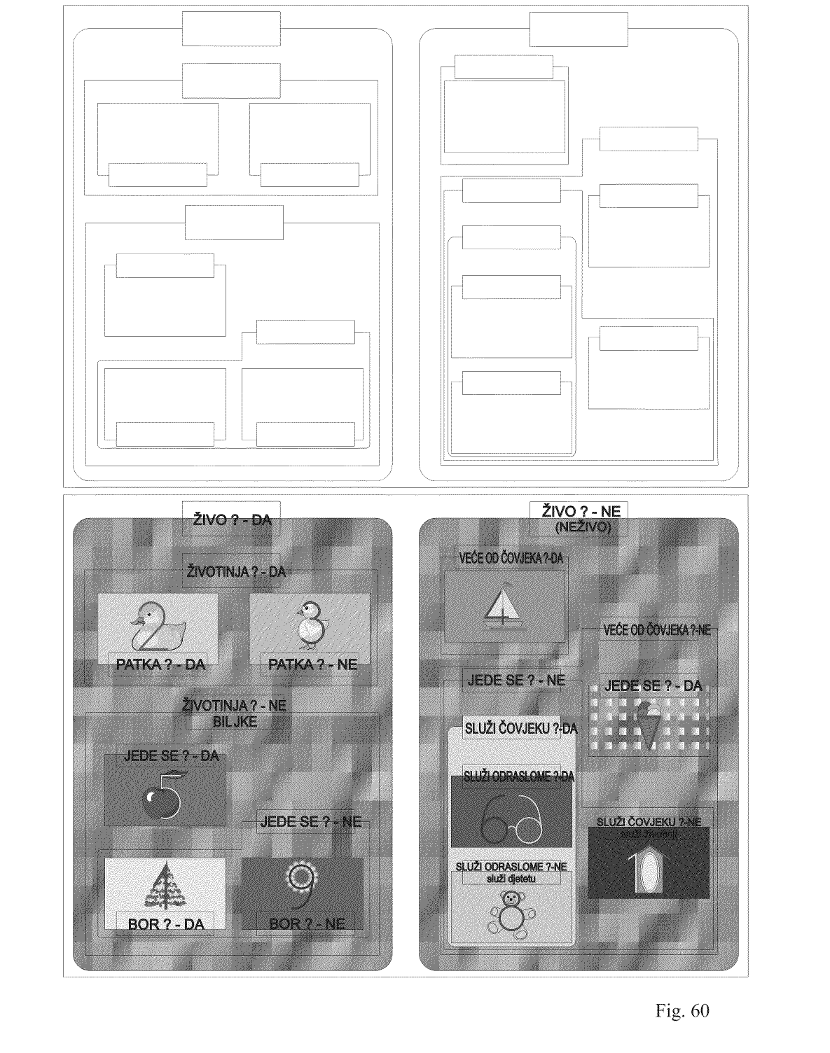

FIG. 60. Transparencies—MENTAL MAPS for isolating the wanted character—symbol, according to the binary categorizing scheme; empty spaces—up, a complete live-dead picture—down

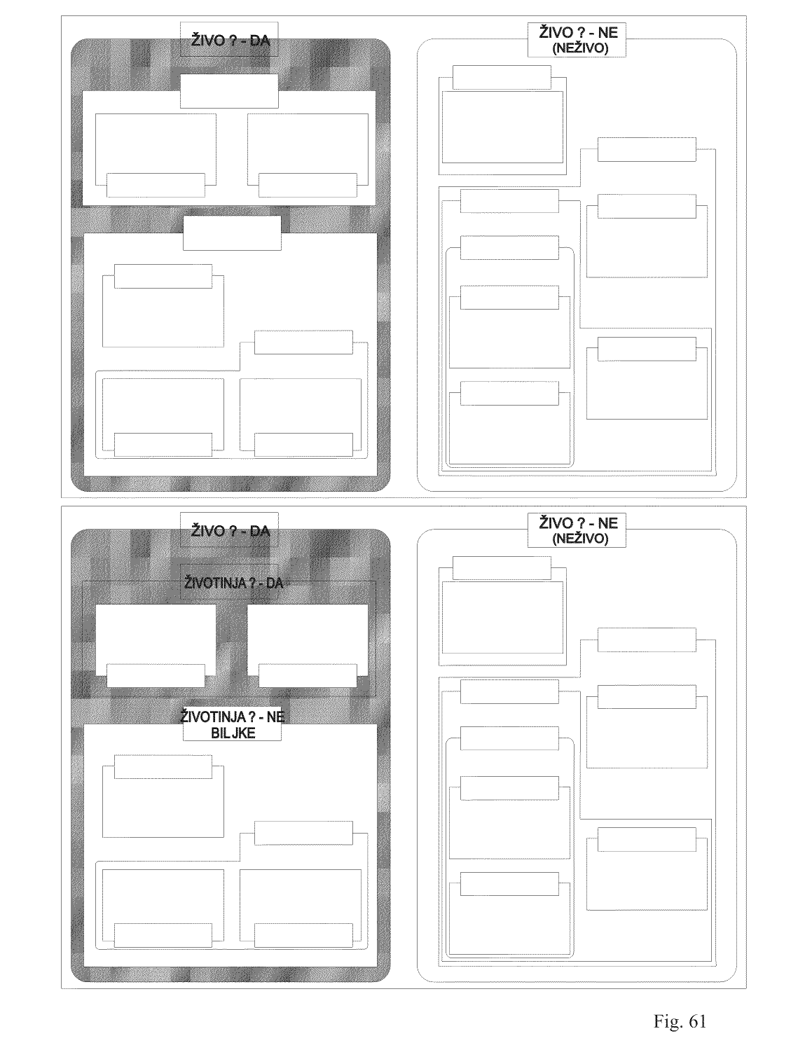

FIG. 61. MENTAL MAPS, continuation; the selection of live—up, and the selection of animals

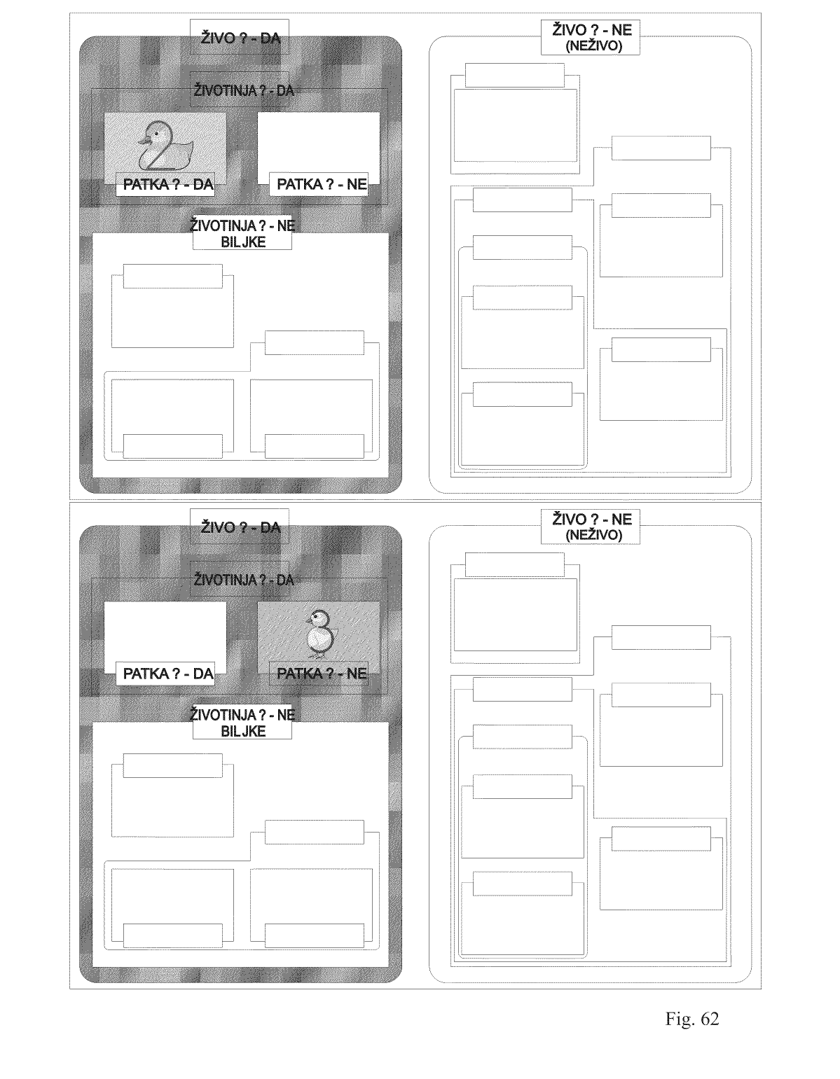

FIG. 62. MENTAL MAPS, continuation; the selection of the duck—yes, or an alternative chicken—no

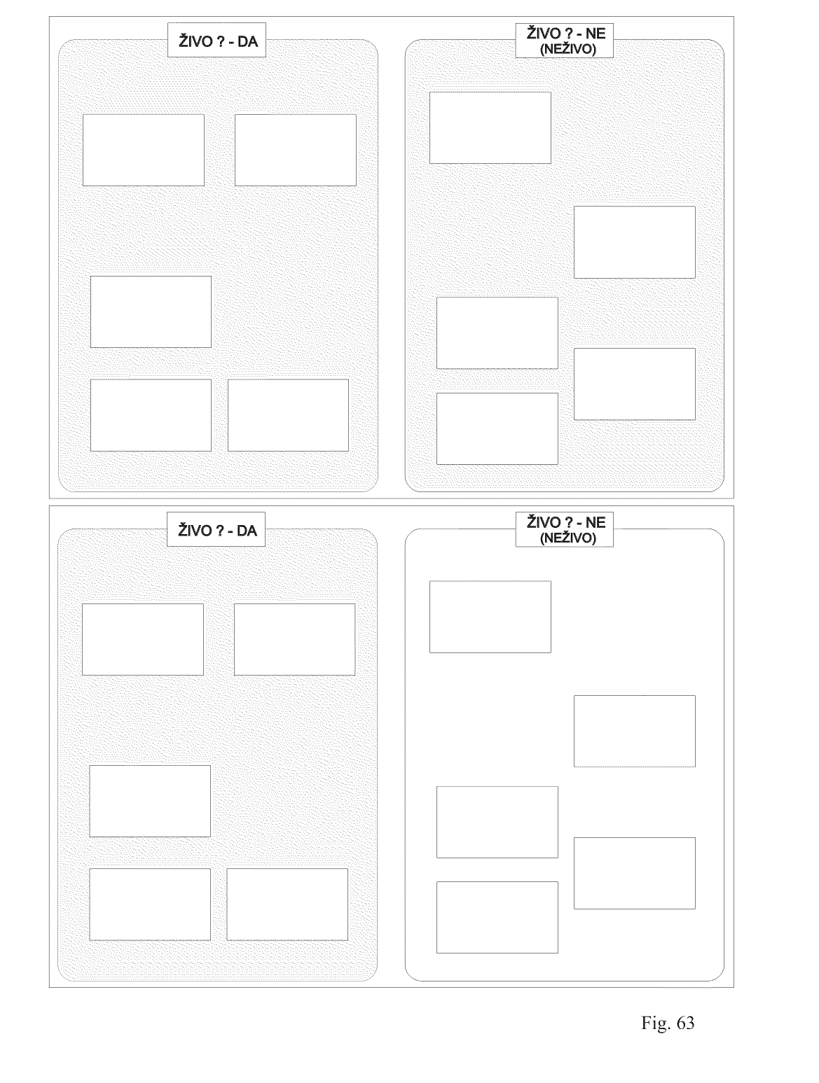

FIG. 63. Frames with empty spaces for a set of number symbols in the mentioned categories

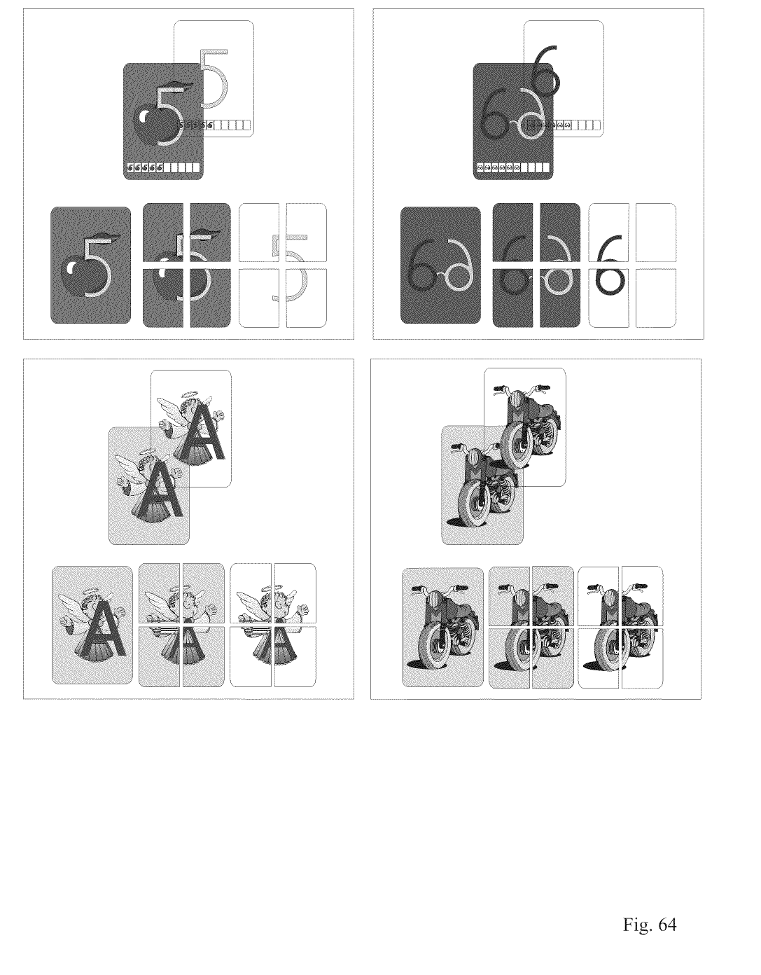

FIG. 64. Transparencies—cut

### 6. ONE OF THE BEST WAYS OF PERFORMING AND FUNCTIONING OF THE INVENTION

JIGSAWS—INSERTERS, FIGS. 1, 2 and 3

Jigsaws—inserters are didactic tools in form of a board with a drawing, whose shape reminds of the shape of a symbol. It activates perception by singling the symbol out of the figure and facilitates memory. Inside the figure, there is a dent for arranging the symbols (numbers and letters) in parts and/or in layers and with quadratic dents for arranging squares. The number of squares equals the number they symbolize, which tools that number 1 has one square with a figure and a symbol; number 2, has two squares; number 3 has three . . . (altogether 55). For arranging letters, number of squares equals the number of letters in a word which signifies the concept shown by the drawing. The parts of the symbol are arranged one next to another, and layers one above another in the dent inside the drawing. Squares are orderly arranged into their dents. Each part of the symbol has its belonging movement when writing (the quantity of writing equals the number of moves), and the direction of writing a symbol is also noted in the dent. This tools is thr first step and a preparation for the important characteristic of the entire set, where numbers are shown in quantities they denote, so that the first 10 numbers have quantity of 55 unit values, and that each value has its colour. Letters also have a sign connected with the meaning in such a way that a figure, which contains the first letter of the word, is a figure that the word (letter) denotes. Complex symbols can be in a level with a pad (board) in which they are arranged, but can also be above it. In that case, they enable understanding only by touch.
MULTIPLICATION TABLE WITHOUT NUMBERS, FIGS. 4, 5, 6, 7, 8 and 9

Multiplication Table Without Numbers is a didactic tools in the form of a square with 100 geometrical figures (10 squares and 90 rectangles) in 10 colours, and with one hundred geometrical figures (10 square and 90 rectangle prisms) in the same 10 colours from the pad on them. Figures on the pad, with their position and size—surface, equal the products of multiplication of the 1-10 multiplication table and together take the area of 55×55 squares, and the parts arranged on it have the same volume. The number of single squares on the pad equals the number of the single cubelets. The parts are joined to the pad according to colour, shape, size and position. They have as many unit values (squares and cubelets) as does the number (the product) they represent. This Table primarily shows the products of multiplication of numbers from 1 to 10 and the surface of squares and rectangles, but there are also many other possibilities. The colour is chosen like in all tools of the set. The lightest yellow for number one; a darker yellow for number two; and for number three even a darker yellow, i.e. with a dose of red it becomes light orange. Number four is even redder, i.e. darker orange; number five is light red; and six is in a darker red. Number seven is even darker and with a dose of blue it becomes purple. Number eight abandons the red hue and continues with blue, so it is light blue; nine is darker blue, and number ten is the darkest—dark blue.

The same colour goes with the same number till its product of multiplication by itself, i.e. till the square, i.e. till the diagonal. Later, the colour of the higher factor continues with the products of multiplication of the same number, so we can say that colour is determined by the higher factor. It goes from lighter to darker hues so that a lower number connects the smaller quantity with the lighter variant, and higher number connects the larger quantity with the darker hues. Human brain functions in the same way. It reads out data by synesthesis and with a certain regularity from one sensory area, transmits them into another sensory area thus creating synthesis of experiences, in this case from visual to kinesthetic and perceptional sensation. Number seven appears as a borderline, or a turning point in the tools of the set, because another colour, maintaining the lighter to darker principle, continues from it. It is no longer the yellow, orange, and red variant, but blue, and number seven is a mixture of blue and red—violet. This is also connected with brain functioning, which is possible to differentiate between seven levels of the same property, in this case seven levels of lightness, i.e. darkness, just like the height of tone arranged in a scale of seven. To us, mathematically interesting is the fact that number seven is just the number which is (most approximately) the half of the sum of numbers from 1 to 10 (which is 55). Namely, the sum of the numbers till seven is 28, and the rest of them, 8+9+10, give 27. That is why number seven is a turning point. Experience teaches us that children, developmentally looking, see numbers over seven as a plural. It is the same with the multiplication. They find multiplication by seven, like 7×6, and 7×8, the most difficult. In the Multiplication Table, number seven is also the only number whose products of multiplication are not found anywhere else in the Table but in its row and its column, which can be explained with its nature of the prime number and the size of the Table. These are the reasons that explain the scale of colours chosen in this way, and its multiple technical characteristic. The scale is chosen in the same way in all the tools of the set. With its mathematical property of equal surface of the figures on a pad with the volume of the parts arranged (always the same numbers in the sum 3025), it directly connects three-dimensionality with two-dimensionality without losing its mathematical essence here or in all other tools of the set. With its display of real quantities and their relations (it can also be called the real Multiplication Table), and of same form, it also enables, besides the above mentioned, the analyses of higher mathematical functions, derivations, integrals, etc. With the variation in the height of the parts, it gains even greater possibilities. Thus, on FIG. 7, the products of multiplication of the same colour primarily show rising to the fourth power. On the other hand, with its appearance (coloured cubelets) and natural way of functioning, which does not have to be learned (because one of the main qualities of a human is to create order and find regularities in the chaos of dispersed parts), it enables creative approach, various games and new mathematical contents.
JIGSAWS WITH THE MULTIPLICATION TABLE WITHOUT NUMBERS
1-10 jigsaw, FIGS. 10.-15., is a didactic tools with arranging pads of numbers from 1 to 10. It has 19 parts of the Multiplication Table Without Numbers of quadratic prisms for numbers from 1 to 10 and back to 1, quantity of 100 unit values. It serves for arranging and displaying the relations between numbers like mathematical sequences, equations of adding and subtracting, showing number 100 in different ways, and the other. All 19 parts together have 100 unit values—cubelets. FIG. 10 shows transparency which points to full and empty squares and together with a frame on which equations are noted it leads into addition and deduction and their reversibility. Coloured pad has the same function, but with its arrangeable parts indicates it in an even more specific way that enables counting of cubelets and adding one to another in new, wanted, combinations. After inserters with 55 parts, this tools leads to comprehension of number 100, connects it with different shapes, and shows its square property, as well as creating squares out of other numbers, FIG. 14. In combination with the dark blue parts of the Multiplication Table without numbers, it also shows ten times larger shapes, FIG. 15. FIG. 14 shows passing over number ten in different ways. All shapes create mental images and serve for comprehending on more levels, from the play of shapes and colours to precise expressing via numbers. By adding stickers (with drawings and symbols) on the parts, everything becomes based on counting, and symbols are learned in relation to their mathematical meaning, which is the number value or quantity.
numeral lines jigsaw, FIGS. 16 and 17, is a didactic tool with the pads for arranging numeral lines of positive and negative numbers from −20 to +20. It contains 60 parts of the Multiplication Table Without Numbers. These parts are: 10 parts for numbers from 1 to 10 and 20 parts for numbers from 11 to 20 (those are ten same as the previous), with another 10 tens, which is altogether 30. We also need the same quantity for negative numbers for displaying values from −1 to −20. Since the Multiplication Table Without Numbers has 19 parts for numbers from 1 to 10, this tool uses spare parts of the same shape, size and colour. The necessary parts together have 440 unit values—cubelets. Numeral lines show numbers in a sequence, but by arranging parts on the pads, they enable adding and subtracting by hands and eye, and counting quantities and results. Here we can also use stickers. The black ones, which show negative numbers, are put on one side of the parts, and the white ones, showing positive numbers, are put on the other, the opposite side. Since the negative numbers are shown in the third quadrant, this tools unnoticeably leads into the coordinate system. In relation to the previous tools, the number of parts is increasing.
decimal system jigsaw, FIGS. 18, 19, 20 and 21, is a didactic tool in three parts for the decimal system and the positional notation of numbers for numbers from 1 to 999. It has 19 parts of the Multiplication Table Without Numbers: 9 parts for ones, 9 for tens and 1 part for the hundred. It has 21 pads, in 3 groups: 10 pads for numbers from 1 to 9 and for zero, 10 pads for numbers from 10 to 90 and for zero, and one pad for arranging number 100. The necessary parts are 9 pieces of the Multiplication Table Without Numbers for ones, 9 pieces for tens and one piece for the hundred, which altogether have 595 unit values—cubelets. The pads can be connected into a triple pad in which we can turn pages. The right pad is for arranging the ones, the middle one is for arranging the tens and one on the left is for the hundred. Historically, a big problem of mathematics was the way of noting numbers and the choice of the system of numbers. Even today, comprehension of the decimal system and the positional notation of numbers is an important problem in elementary mathematics learning. Numbers are written from left to right, and their values grow from right to left; ones, tens, and hundreds are noted with same figures and with this tool, the system is clearly displayed. When turning pages of the right pad the ones, shown with squares on the bottom of the page, grow. On the next-upper part of the next page, a symbol for the belonging quantity is written. They grow to number 9, and the ten is in a new pad—left, in a new position. All ones are light yellow, and the ten has an dark blue colour on the one side and it touches the arranging pad. In the same way, tens and the hundred have dark blue colour at the bottom, and at sides, they have a colour of the quantity of tens. At the top they are identical with the pad they are arranged on, which is orderly in colours for one, for two, for three tens always the same sequence in the entire set, FIGS. 19 and 20. FIG. 21 shows a three-part pad for turning pages, without complex parts at the top, and with parts at the bottom.
cubes jigsaw, FIGS. 22, 23 and 24, is a didactic tool, which uses all parts of the Multiplication Table Without Numbers, as well as 10 squares of the main diagonal on the Table For Arranging Parts pad. Each cube is created with the sum of products of multiplication of that number, sequentially from 1 to the product of multiplication of that number by itself and has its belonging colour. Boxes for the cubes (10 boxes) of numbers from 1 to 10 are of the same colour and size as are the belonging cubes. By adding the products of multiplication of the same colour or by adding the products of multiplication from n to n², we get cubes or n³. Boxes of the same colour and size without instructions and lessons enable arranging of the parts in a given shape and prevent creating shapes that are not cubes, which is permitted in free learning the Table.
binomial theorem jigsaw, FIGS. 27, 28, 29 and 30, is a square of the sum of numbers within the ten (for arranging the sum above eleven the pad should be larger, but the principle can also be introduced on this pad with small numbers). The parts can serve for the demonstration of the familiar way (a+b)²=a²+2ab+b², but the Table also enables a new way shown by tools of the products of multiplication which are being added and give the same result. They are equally distanced from the central products of multiplication of the table that is used as a pad. The distance is not measurable by length but by the position of the product of multiplication—a part visibly shown in the figures.
mathematical sequences jigsaw, FIGS. 32. and 33., is a didactic tools for the sequences of number squares from 1 to 10. It uses 10 parts of the Multiplication table without numbers, which are positioned on a main diagonal of the Table, and its base is quadratic. FIG. 32 shows the arranged parts, and FIG. 33 shows the layout of centrally arranged parts. These three sequence square sums create simple mental images, which are, in mathematics, usually shown with the following formulas:

$${\sum }_{ } {1}^{2} + {3}^{2} + {5}^{2} + {7}^{2} + … + {( 2 n - 1 )}^{2} = \frac{n ( 2 n - 1 ) ( 2 n + 1 )}{3}$$

$${\sum }_{ } {2}^{2} + {4}^{2} + {6}^{2} + {8}^{2} + … + {( 2 n )}^{2} = \frac{n ( 2 n + 1 ) ( 2 n + 2 )}{3}$$

$${\sum }_{ } {1}^{2} + {2}^{2} + {3}^{2} + {4}^{2} + … + {n}^{2} = \frac{n ( n + 1 ) ( 2 n + 1 )}{6}$$

JIGSAWS FOR THE DECIMAL SYSTEM AND THE POSITIONAL NOTATION OF NUMBERS—CYLINDERS, FIGS. 34., 35., and 36.

This is a didactic tool created from 3 cylinders, which, separately, rotate on the same axle, and serve for displaying the decimal system and positional notation of numbers from 1 to 999. The right cylinder serves for displaying the ones from 1 to 9 and is ten times smaller than the middle cylinder, on which tens, from 10-90, are displayed. The middle cylinder is ten times smaller than the left one, on which hundreds (from 100 to 900), are displayed. Squares in ten colours, whose quantity is identical to the number being shown, are positioned on the cylinder sheet. All cylinders together have 4500 squares (hundreds), 450 (tens), and 45 (ones). Displaying is realized so that the wanted quantities, with their bottom part, equate with the white line on which that transcript is read, FIG. 36. If you choose sizes of 1 cm for ones, 1 dm for tens and 1 m for hundreds for cylinders, you compare the lengths at the same time.
MULTIPLICATION TABLE IN HEIGHT, FIGS. 37, 38, 39, 40, and 41

This is a didactic tool with 100 squares in 10 colours pad and a hundred parts in a shape of quadratic prisms with the base of one square, size and number of squares identical to the quantity of the product. Growth of the products of multiplication of numbers from 1 to 10 is shown by the growth of the square prisms' height. The pad of the Table in height has colour for the products of multiplication in the same position as the Multiplication Table Without Numbers, with the difference in that all the products of multiplication are of the same size, and it is identical to 100 cubes multiplication table pad. Quadratic prisms, arranged on the pad, have just as many single cubes as is the quantity of the product of multiplication they represent, and their base of one square is of the same size and colour as is the square on the pad. The parts can also serve for the comparison of the lengths, adding, subtracting, etc.
100 CUBES MULTIPLICATION TABLE, FIGS. 42, 43, 44, 45, 46, 47, 48, 49, 50, and 51

This is a didactic tool with 6 basic pads and 100 cubes with the data, on their 6 sides, that are belonging to the data on the 6 pads. The pads are: the main pad—the Table made of 100 squares and in 10 colours organized as a sequence of odd numbers from 1 to 19, quadratically positioned, and whose sum is 100. It is identical to the Multiplication Table in height pad. The Products of Multiplication Table, Factor Table, Division Table, ordinal numbers from 1 to 100 table, the even and odd products of multiplication of the multiplication table.

Regardless of the large number of combinations and possibilities, the tool is understandable, thanks to the colour and the colour positions. Even on this pad, the squares for surface, i.e., the size of the products of multiplication can be counted although they have symbols on themselves. For example, the product of multiplication 15 can be found in a rectangle on whose right bottom corner it is positioned, and whose sides are 3 lengths of the first row of the square, and five lengths of the first column, and sides parallel with them, which close the surface of the rectangle with just (those) 15 squares.

Space for arranging squares is not necessary, but it represents the better shape, because it can stand vertically and it closes the data on the sides of squares, which do not interest us. By arranging this Table the symmetricalness of the Table, interchangeability and distribution are noticed, this in an active and individual way in accordance to the possible level of comprehension. Processes and orders of the wanted, the mentioned and the unmentioned mathematical operations, can be ensured, from simple arranging according to colour to adding sequences, and in combination with transparencies and frames with empty spaces. In the FIGS. 48, 49, 50 and 51 some simple, useful, and interesting examples are mentioned. It can easily be used for various familiar games such as Bingo, Sea Battle, and it also contains other, simpler, games. It also contains software, like all mentioned didactic tools.
MENTAL MAPS IN LAYERS—TRANSPARENCIES

These are didactic tools in the form of transparencies (more of them in groups), which are of the same size, for displaying specific contents. Each of the transparencies separately has a part of the wanted information, and arranging one on top of the other or taking some transparencies off, information are joined or eliminated. With the arranging of all disposable transparencies, a complete image of what is wanted to be shown is created, and by taking the transparencies off data is disassociated, thus with their elimination we come to what we want to separate. On each separate transparency, the position of the data is defined so that they together create the wanted, complete image. If the same data comes on more transparencies (same part of the image), it is always in the same position. Some transparencies on a white pad can also serve as arranging pads.

By transparencies we can show processes, chronology of events, arranging, sequence of opinions, categorizing, mathematical sets and subsets, projects, or any other phenomenon with the data which is joined, disassociated, grouped, arranged, and the like. Transparencies can be used in combinations with all didactic tools this set contains, so that by arranging and displaying they create new mental images suitable for understanding and memorizing of wanted mathematical concepts and processes, like:
for arranging and displaying, symbols and quantity, numbers and letters, FIGS. 58, 59, and 64. This tool has a displayed figure which by its shape reminds of the shape of the symbol (number and letter). In FIG. 58, in the upper part there is a complete image with all the wanted data, while in the lower, some are kept and some are gone. Separation of the symbol from the figure in which it is positioned is made, and the separation of the quantity a number symbolizes from the symbol itself and other variants is also possible. With letters, a symbol-letter is also placed on a separate transparency. Both the figure it symbolizes and the word, which signifies the figure, are put separately. Other combinations are also possible, as we can see in the FIGS. 58 and 59. In the FIG. 64, transparencies are joined to the pad and they are (both) also cut in the direction up-down and left-right so that they serve for shape analysis in more than one way.
for arranging and displaying the Multiplication Table Without Numbers, FIGS. 4 and 6. They are as big as the pad and can be used for different demonstrations. For example, putting the transparency with squares (FIG. 4), or with symbols (FIG. 9) on the Table pad; for displaying the products of multiplication arranging according to the Table rows, which is created by putting the transparencies with the products of multiplication of the first row orderly, then the transparencies with the products of multiplication of the second row, etc. one on top of the other, creating the images of yet more arranged rows. They can also be used for joining different data to the Table, e.g. transparencies with numbers—products of multiplication symbols in spaces that suit exactly them, FIG. 6.
for arranging and displaying numbers from 1 to 10, FIG. 10. For example, equations and a drawing with a number symbol are joined with the part which has just as many squares on a pad as there are symbols—drawings, FIG. 10.
for arranging and displaying the numeral lines of positive and negative numbers, FIGS. 16 and 17. For example, colours with squares or without them (all on separate transparencies) can be joined to a colourless transparency with a clearly defined shape, and the like, or they can display addition and subtraction by displaying the order of adding and subtracting.
for arranging and displaying the decimal system and the positional notation of numbers. By turning the transparencies in order, we can display the orderly growth of the numbers, and the like.
for arranging cubes on squares in a specific colour, FIG. 22. For arranging transparency in this figure separates wanted part of a pad on a white pad.
for arranging the sequence of squares, FIG. 33. They can be put one on top of the other, just as the parts of the Table. To avoid mixing of colours, white squares of the same size are be put between them. By this we get the same layout as is the layout of the sequence of squares by tools of the Multiplication Table Without Numbers parts.
for arranging and displaying the result of the square of the sum of the binomial theorem, FIGS. 27, 28, 29 and 30. By tools of parts and positions of the Multiplication table without numbers, it becomes obvious via transparencies, which orderly separate the position of a pad on which movable parts are arranged. The choice of four products of multiplication of the Table which, summed up, give a result of a square of the wanted sum is displayed on the transparencies. On 100 cubes multiplication table pad, the position of the chosen products of multiplication, which summed up give the square of the sum, is equally distanced from the centre of the Table, and it is easier to see than the Multiplication table without numbers pad. Here there are no parts that, when arranged, give a result, so only addition, and not counting, is possible, FIGS. 54 and 55. Parts of the Multiplication Table Without Numbers and transparencies enable comparison of the new way with a classic formula, that can also be displayed successfully and obviously with the existing parts.
for arranging and displaying the calculus of the Pitagora's theorem, FIGS. 31, 52 and 53, of the isosceles triangle by tools of a colourless Multiplication Table Without Numbers and transparencies in 10 colours, which are arranged on a pad in order. This enables counting of the squares over kathets and the square over the hypotenuses, sequential comparison of the square growth for the sequence of the natural numbers and creating new mental maps, FIG. 31. The image of Pitagora's theorem by tools of colourless 100 cubes multiplication table pad, with transparencies sized as the squares over the hypotenuses (FIGS. 52 and 53), clearly shows the size of the square over the hypotenuses, because its peaks on the Table (square is turned over the triangle and it is on the table) touch the product of multiplication of that very size, FIG. 53.
for arranging and displaying of squaring the circle calculus, FIGS. 25 and 26, by tools of the Multiplication table without numbers pad and transparencies, by isolating specific parts of the pad. Analysis of the opposite diagonal of the Multiplication Table Without Numbers displays the distribution of the products of multiplication (not on a straight line as if it is the case with the main diagonal, but its distortion like the fourth of the perimeter of the circle). The distortion is even more obvious by tools of transparencies on which diagonals of those rectangles are noted, FIG. 25. It is also possible to count the squares and rectangles, but for rectangles on the opposite diagonal we calculate their half, and in a sum with other parts it gives an approximate value of ¼ of the circle. By arranging four transparencies, we get a circle, FIG. 26.
for displaying the size of the sheet of cylinder, FIGS. 35 and 36
for arranging and displaying the binomial theorem, FIGS. 54 and 55, by addition of the products of multiplication determined by their position in the 100 cubes multiplication table, noted down on transparencies. At the 100 cubes multiplication table pad, the position of the chosen products, which added give the square of the sum, is equally distanced from the centre of the Table and it is easier to comprehend than the Multiplication Table Without Numbers pad, but there are no parts which arranged give the result, so there is no possibility of counting but adding.
for arranging and displaying the Pitagora's theorem, FIGS. 52 and 53, of isosceles triangle with the 100 Cubes Multiplication Table, by overlapping of transparencies in ten colours for the first ten numbers, in size of square over the kathets and square over the hypotenuse over the triangle, according to the colourless products of multiplication table pad, in whose peaks we read the result of the square over the hypotenuse, which is equal to the product of multiplication in that position. The illustration of Pitagora's theorem by tools of the colourless 100 Cubes Multiplication Table pad, with the transparencies in size of square over the hypotenuse, FIGS. 52 and 53, also clearly displays the size of square over the hypotenuse because its peaks on the Table (square is turned over the triangle and it is in the Table) touch exactly the product of multiplication of that size, FIG. 53.
for arranging and displaying the two-way-rotational table, FIG. 57, which displays the relation of ordinal numbers and the products of multiplication of the Table.
for arranging and displaying different data connected to the Multiplication table in height pad, FIGS. 48, 49, 50, and 51, which is identical to the basic 100 cubes multiplication table pad.
for arranging and displaying other mathematical contents connected to the Table analysis, FIGS. 49, 50 and 51. The fact that there are only 25 odd numbers in the 1-10 multiplication table is distant to grown-ups, because they learned in a different way and developed different brain patterns, so, beside the possibility of watching, they perceive badly and see that fact with difficulty (they often think that there is a half of it—50). The analysis variations of evenness and oddness of numbers are also basic, not only in mathematics, and because of that, this set contains many of them and in different ways. There is an example in the lower drawing, FIG. 55. Even and odd numbers in diagonal (even ones—light green) and all the numbers around the even products. The marked numbers around the odd products of multiplication give a very different picture.
for arranging and displaying logical mental processes, categorizing and isolating the elements from sets according to binary scheme, FIGS. 60, 61, 62 and 63, with the questions ALIVE? and answers YES or NO. If it is YES, the question is ANIMAL? with the answer YES or NO. Furthermore, if it is an animal, it can be a duck YES or NO. If the answer is no, then it is a chicken, because a chicken is a Duck? NO. If it is not an animal, the other sequence of questions follows etc.
for arranging and displaying other schemes of any wanted contents

It is easy to imagine, for example, the time-table for time and subjects in school, according to any classification, which together create the image of the week, for example isolated subjects or isolated days etc.
OPAQUE FRAMES WITH EMPTY SPACES, FIG. 63.

These are didactic tools for displaying the isolated parts of pads with data. By arranging more frames one on top of the other, the wanted sequence is enabled. Yet larger empty spaces display yet more data, and the smaller ones yet less data. Thus by tools of this aid, by arranging one on top of the other, the data is eliminated, just as by taking off one from the other, the data is added. It will be possible to use this tools independently, without a pad in which all the data are placed, only as a frame which determines the largeness and shape of the arranging space for single parts. Combined with the didactic tools of this set (pads and parts), by arranging and displaying, it will create new models, illustrations and mental images suitable for understanding and memorizing the wanted mathematical concepts and processes. We would be able to use them, just like the transparencies, just as the mental maps with all the didactic tools of the set, as for arranging and displaying other contents.

### 7. INVENTION APPLICATION

All tools can be used in kindergartens, schools, universities, educational camps and in all places for learning and entertainment, as well as in mathematical cabinets for research of new ways of learning.

1. Didactic tools for learning the mathematics, wherein they are interrelated by the same way of functioning; they are interrelated by colour arrangement which makes the basic principle of that arranging, and is systematically connected to numerical value. The numerical value is, besides with colour, presented by quantity of unit values, by which it becomes the real presentation of quantities and their relations, and can be checked by counting; in all didactic tools there is selected the same example of constant 10 colours, which from lower to higher numbers go from lighter to darker colours, and the example of constant presentation of unit values, by a square on the arranging pad and a cubelet in belonging parts, whereas diversity of mathematical contents is displayed by different organization of colours and quantities in space, i.e. by different shape and position; this didactic aid, by tools of natural logic and mathematical pre-skills (sorting, joining, equalizing, arranging in order etc.), instead of with mathematical language of symbols and formulas, make mathematical relations understandable in a visible and tangible way, without special instruction and additional guidance, to include:
JIGSAWS—INSERTERS
MULTIPLICATION TABLE WITHOUT NUMBERS JIGSAW
JIGSAWS WITH MULTIPLICATION TABLE WITHOUT NUMBERS
1-10 jigsaw
numerical lines jigsaw
decimal system jigsaw
cubes jigsaw
binomial theorem jigsaw
sequences jigsaw
JIGSAW FOR DECIMAL SYSTEM AND POSITIONAL NOTATION OF NUMBERS—CYLINDERS
IN-HEIGHT MULTIPLICATION TABLE JIGSAW
100 CUBES MULTIPLICATION TABLE JIGSAW
MENTAL MAPS IN LAYERS—TRANSPARENCIES for arranging and displaying of:
symbols and quantity of numbers and letters
Multiplication Tables Without Numbers
numbers from 1 to 10
numeral lines
decimal system and positional notation of numbers
cubes
square sequences
binomial theorem by tools of Multiplication Table Without Numbers
Piragora's theorem by tools of Multiplication Table Without Numbers
squaring the circle by tools of Multiplication Table Without Numbers
cylinder sheet
binomial theorem by tools of 100 cubes Multiplication Table
Pitagora's theorem by tools of 100 cubes Multiplication Table
two-way rotational tables
various data of the 100 cubes Multiplication Table
other mathematical contents
logical schemes (categorizing and the like)
other schemes of any wanted contents.
OPAQUE FRAMES WITH EMPTY SPACES

2. Didactic tools, according to claim 1, wherein they systematically use the same 10 colours in all the tools, linked to numeral value (quantity), by which the colour becomes an information (sign) for that value (which is a concept, i.e. the meaning of that sign). Besides linking with the quantity, the 10 colour among themselves create the colour scale of lighter to darker colours, which corresponds to the sequence of numbers from lower to higher, and is neurophysiologically established (by synesthesion) by relating lighter colours to easier, smaller and lower number, and darker to more difficult, bigger and higher number. The colour is also a category by which the parts are classified in the arranging process. It is also a relationship between the arranging parts and the parts of the pad in the same colour, which are, besides with colour, equalized by size, shape and position, by which the colour becomes a relationship between number and space. In parts of the same size but of different shape, the colour is an additional distinctive value, indicating the origin of that size.

3. Didactic tools, according to claim 1, wherein through the existence of the unit value (in the given example of all tools these are a square and a cubelet) for each numeral value (with or without colour), systematically use the real presentation of quantities (sizes) by which, without but also with the use of symbols, enable checking of sizes and their relations—by counting, i.e. adding. Also, since the sizes are organized into shapes, this also enables equalizing by shape, by placing several different sizes in the same shape. Equal sizes are arranged into different shapes, which is equalizing by quantity, and both equalizations create a direct connection between arithmetics and geometry.

4. Didactic tools, according to claims 1, 2 and 3, wherein they have more common characteristics which make the invention unique. The connection of the sign and the meaning is obvious, it is not available to agreement or arbitrary, and it does not have to be specially learned. Three-dimensionality of the tools is in all their essential qualities presented in two-dimensional presentations, pads and transparencies (square surface and cubelet volumes are expressed by the same number). Presentations, pads and transparencies make the global picture of concepts and mathematical contents, and function as mental maps, and the three-dimensional parts as models of mathematical content. All didactic tools are enabled countability, which means that all the quantities and their relations can be counted or added. All the tools are jigsaws based on natural stimulus to create order out of chaos, whether the parts are arranged mutually, on the pad, one on top of the other or one beside the other. All the tools enable numerous combinations, thus having a property that can be called productivity. They have implicated various softwares and can easily be translated into a computer medium and become various games.

5. Didactic tools, according to claims 1, 2, 3 and 4, wherein JIGSAWS—INSERTERS, besides the mentioned characteristics, bear a drawing that indicates the symbol's shape; the symbol is in parts and/or layers which are divided in a way that they represent a writing movement, also indicated in a dent, and that they have quantities of represented number indicated by squares.

6. Didactic tools, according to claims 1, 2, 3 and 4, wherein MULTIPLICATION TABLE WITHOUT NUMBERS, besides the mentioned characteristics, is a didactic tools with a square-shaped pad with 100 geometric figures (10 squares and 90 rectangles symmetrically arranged relative to the main diagonal) in 10 colours, and with 100 solids (10 quadratic and 90 rectangular prisms, which, by its one side, has surface identical to the figures on the pad) in the same 10 colours as the pad, where figures and solids on a pad, by their position and size-surface, correspond to the products of multiplication of the 1-10 multiplication table and together they take the area of 55×55 squares. The parts which are composed on them have the same volume, and are arranged so that in the first row, from left to right, there is the lightest square, and next to it a little darker rectangle, placed horizontally, in the size of two squares, then the third one placed similarly, composed of three still darker squares, etc. till 10, till the darkest rectangle wih a base 10 and height 1. Thus, the first row has the quantity of 55 squares, which is a number quantity from 1 to 10, the second one double—110, the third one triple—165, etc. till the tenth row, which contains tens from 1 to 10 tens, which totals to 550. Columns have the same numeral values as the rows, but rectangulars are placed vertically in the way that base 1 is in the first row, and heights, one after another, from 1 to 10. Thus, in the main diagonal there are the squares, i.e. products of multiplication of numbers by themselves; that colour is determined by higher factor or, in other words, all the sums of n number, from one to n², are of the same colour wherefore there is one lightest square (cubelet) in the sum, then three parts in a darker colour, then five still darker, then seven still darker etc. till 19, which is the number of parts of the darkest color, which grow as a sequence of odd numbers that creates squares or square numbers by joining; the number of single squares on a pad corresponds to the number of single cubelets; the parts are joined to pad according to colour, shape, size and position; they have the same number of unit values (squares and cubelets) as the number (product) which they represent; this Table primarily displays the products of multiplication of numbers from 1 to 10 and surfaces of squares and rectangles, but there are many more possibilities. Possibilities grow with variation of part heights.

7. Didactic tools, according to claims 1, 2, 3, 4 and 6 wherein the JIGSAWS WITH THE MULTIPLICATION TABLE WITHOUT NUMBERS are differentiated by the arrangement on the pad, by quantity of the necessary parts, by the use of the mark of colour or drawings on parts.

8. Didactic tools, according to claims 1, 2, 3, 4 and 6, wherein use the Multiplication Table Without Numbers, with variation of the arrangement on the pad and the quantity of parts in the didactic tools; that the decimal system jigsaw pads will be arranged in a triple pad, which, when pages are being turned, can display numeral values from 1 to 199 and digit position for each of them.

9. Didactic tools, according to claims 1, 2, 3, 4 and 6, wherein cubes jigsaw uses the Multiplication Table Without Numbers, its pad and all the parts, and 10 boxes of the same colour and size, for arranging the sums of the same colour into a cube.

10. Didactic tools, according to claims 1, 2, 3 and 4, wherein the JIGSAW FOR DECIMAL SYSTEM AND POSITIONAL NOTATION OF NUMBERS-CYLINDERS, besides the mentioned characteristics, use three cylinders, which, separately, spin in the same axle and serve for presentation of decimal system and the positional notation of numbers from 1 to 999; the right cylinder serves for displaying ones from 1 to 9 and it is ten times smaller than the middle cylinder, on which the tens from 10 to 90 are displayed; the middle cylinder is ten times smaller than the left one, on which hundreds from 100 to 900 are displayed: squares in ten colours, whose quantity is identical to number that presents, are placed on the cylinder sheet.

11. Didactic tools, according to claims 1, 2, 3 and 4, wherein the MULTIPLICATION TABLE IN HEIGHT, beside the mentioned characteristics, has a pad in the form of a square, composed of 100 squares in ten colours; 1 square in the brightest colour for the product of multiplication 1×1, three somewhat darker squares for the products of multiplication 2×1, 1×2 and 2×2; 5 squares for the products of multiplication 3×1, 3×2, 1×3, 2×3 and 3×3 etc. till the product of multiplication of number 10 in dark blue, and the products of multiplication by number one in the table's first row and the first column in order from 1 to 10, and the products of multiplication of numbers by themselves on the table's main diagonal and from hundred parts in the form of quadratic prisms; a didactic tools with a pad in a hundred squares in ten colours and hundred parts in the form of quadratic prisms with a base of one square, which is of the same size and colour as the square on the pad, and the increase of the products of multiplication of numbers from 1 to 10 displayed by the height of the quadratic prisms.

12. Didactic tools, according to claims 1, 2, 3 and 4, wherein the 100 CUBES MULTIPLICATION TABLE, besides the mentioned characteristics, didactic tools with six basic pads and hundred cubes with data on their six sides, which belong to the data on six pads; the pads are: 100 cubes multiplication table main pad in ten colours is organized as a sequence of odd numbers from 1 to 19, which are quadratically arranged and whose sum is hundred and that is identical to the MULTIPLICATION TABLE IN HEIGHT pad; Product of Multiplication Table, Factor Table, Division Table, Ordinal Number From 1 To 100 Table, and Even and Odd Products of Multiplication Table.

13. Didactic tools, according to claims 1, 2, 3 and 4, wherein mental maps in layers—transparencies are didactic tools in the form of transparencies in groups, which are of the same size for displaying of particular contents, from which each transparency separately has a part of the wanted information, and by arranging one on top of the other or taking off some transparencies, the information are joined or eliminated; the complete picture of what we want to display is created by arranging all the available transparencies; the data is disassociated by removing the transparencies and by eliminating them we come to what we want to isolate; on every separate transparency the position of data is determined in a way that they together create the wanted complete picture; if there is the same data is on several transparencies (the same part of the picture), it is always in the same place; some transparencies on a white pad can also serve as the arranging pads, and by tools of them, all the contents which are displayed by the mentioned didactic tools, but other contents also, can be displayed.

14. Didactic tools, according to claim 1, wherein the opaque frames with empty spaces are didactic tools for displaying the isolated parts of pads with data; the wanted order is enabled by arranging more frames one on top of the other; yet larger empty spaces display yet more data and the smaller yet less data. By these tools, by arranging one on top of the others, the data is eliminated, as well as the data is obtained by taking off one from another; these tools can be used independently, without a pad on which all the data is placed, only as a frame which determines the size and the shape of the space for arranging the single parts; in combination with the didactic tools from this set (pads and parts), by arranging and displaying, new models, presentations and mental maps suitable for understanding and memorizing of the wanted mathematical concepts and processes, will be created; as well as the transparencies, they will be used as mental maps with all the didactic tools of the set, and also for arranging and displaying the other contents. Size of the frame for displaying of the specific same contents is the same, and the empty spaces are in the same place for the same data.
